(19) United States
(12) Patent Application Publication
(10) Pub. No.: US 2012/0078659 A1
(43) Pub. Date: Mar. 29, 2012

(54) METHOD AND SYSTEM FOR FACILITATING CLINICAL RESEARCH

(76) Inventors: Ali Ashrafzadeh, San Francisco, CA (US); Amir Ali Tabarrok, San Jose, CA (US)

(21) Appl. No.: 12/890,799

(22) Filed: Sep. 27, 2010

(51) Int. Cl. G06Q 50/00

(52) U.S. Cl. 705/3; 705/2

(57) ABSTRACT

A method of facilitating clinical research. The method includes receiving at least one research criteria and at least one comparison criteria, e.g., demographical information, patient characteristic, patient health, type of drug, drug classification, insurance type, etc. A database storing medical records associated with patients may be accessed. Information within the database may be filtered based on the research criteria to identify a group of patients. The information within medical records of the group of patients is processed to generate processed information, wherein the information is associated with the at least one comparison criteria. The processed information is output, e.g., to a memory component for storage, to a display for rendering, etc. The processing may include purging confidential information associated with the group of patients according to HIPAA. A number may be assigned to each patient within the group of patients for identification thereof.

### TECHNICAL FIELD

The present invention relates to the field medical research. More particularly, embodiments of the present invention relate to methods and systems for facilitating medical related research clinical using a graphical user interface.

### BACKGROUND

In general, there is limited information related to a newly approved drug after it has been approved by the federal drug agency (FDA). For example, information about the side effects or adverse interactions of the newly approved drug with other medications may be limited due to relatively small sample of patients studied during the approval process of the new drug. Accordingly, the FDA and the public require additional studies to be performed after the drug approval.

Unfortunately, not only traditional post market clinical research, as required by the FDA, is expensive and time consuming due to its manual nature, but it is also limited because of a small number of patients studied. For example, two groups of patients may be monitored for years where one group takes the prescription drug and the other group is involved in a different standard therapy. Various adverse effects of the prescription drug and/or other standard therapies may be manually studied.

Unfortunately, enrolling patients in post market clinical research for a given prescription drug is difficult because of strict qualification requirements in addition to significant expense associated therewith. In general, physicians are contacted individually and are asked to provide a list of patient candidates that may qualify to enroll in the traditional post market research for a given prescription drug. This process is manual, time consuming, and expensive.

Not every patient candidate may wish to participate in the traditional post market clinical research associated with a prescription drug for various reasons such as privacy concerns. Additionally, stringent requirements such as subjecting the patients to various tests and examinations increase the difficulty in enrolling patients. Accordingly, very few patients may be willing to participate in the traditional post market clinical research for a given prescription drug.

Not only drug manufacturers have limited information regarding a given drug after its approval by the FDA, they have limited data regarding patients' characteristics associated with prescription drugs. For example, drug manufacturers have limited data on their market shares in various geographical locations, demographic information of patients, reasons that a particular treatment has been chosen for a given patient, socioeconomic standing of patients, insurance type, reasons that a particular drug or drug classification has been prescribed for a given patient, possible interactions with other drugs, possible adverse effects, etc. Thus, drug manufacturers ineffectively market their products to everyone instead of a small segment of the society based on their characteristics.

### SUMMARY

Accordingly, a need has arisen to facilitate an automated clinical research as well as medication post marketing research without inconveniencing patients or compromising their privacy and while reducing expenses associated therewith. It is further advantageous to provide drug manufacturers with an effective marketing tool by enabling them to study patient characteristics and demographical information associated therewith. Moreover, it is advantageous to enable drug manufacturers to study the effect of their drugs, their efficacy, and side effects thereof automatically, in a cost efficient manner, and without inconveniencing patients. It will become apparent to those skilled in the art after reading the detailed description of the present invention that the embodiments of the present invention satisfy the above mentioned needs.

According to one embodiment of the present invention, patient related information is received electronically, e.g., using electronic medical record. Patient related information is confidential and remains confidential between physicians and patients. Patient related information may include information that identifies the patient, e.g., name, social security number, address, etc., as well as information regarding the patient's health, e.g., patient's history, physical examination, diagnosis, treatment, etc. Patient related information may be stored locally or in a remote server accessible to the physician treating that patient.

Physicians treating the patient or a drug manufacturer may wish to access patient related information for various purposes, e.g., study the side effect of a particular drug or drugs, efficacy of a given drug, marketing purposes, etc. Although physicians treating patients have access to patient related information, including confidential information, the drug manufacturers are not privy to such information in order to protect patients' privacy and further to comply with health insurance portability and accountability act (HIPAA).

In one embodiment, information that identifies patients, e.g., name, address, social security, etc., is purged in accordance with HIPAA in order to provide a drug manufacturer or any research group access to information related to patients' health and demographic information. Accordingly, the information that remains is specific to patients' health and characteristics without revealing their identity or private information thereof, in accordance with HIPAA. For example, patients' health and characteristic information may include a given condition, diagnosis, prescription drug, side effects, age group, geographical location, insurance type, drug classification, etc., that may be studied for clinical research or public health purposes. In other words, purging certain information, e.g., name, address, etc., associated with a given patient renders the identification of the identity of that patient difficult, thereby complying with the requirements of HIPAA.

According to one embodiment, a graphical user interface (GUI) is provided. The GUI may be used to obtain certain information related to a group of patients. The GUI may be used to enter certain research criteria factors in order to identify a group of patients satisfying those research criteria factors. In other words, research criteria factors are used to scan through a database storing patients' information in order to filter out and identify a group of patients that are of an interest in a particular study, e.g., patients that are diagnosed with Crohn's disease. The research criteria factors may include age, gender, race, geographical location, symptoms, diagnosis, treatment, insurance type, drug classification, and drugs, but is not limited thereto. Accordingly, a group of patients that satisfy the research criteria factors may be identified, e.g., patients diagnosed with Crohn's disease that are between the ages of 20-35.

It is appreciated that the identified group of patients may be rendered to physicians treating the identified group of patients without removing their confidential information. It is, however, appreciated that rendering the identified group of patients to a researcher other than physicians treating the identified group of patients requires the confidential information, e.g., information that identifies the patients, to be removed in accordance with HIPAA prior to rendering.

A researcher or the physician may select a patient from the identified group of patients. Patient selection may provide additional information associated with the selected patient. For example, assuming that a research criteria factor is to identify patients with Crohn's disease, selecting a patient that has Crohn's disease may reveal that the selected patient also suffers from Spondylitis disease. It is appreciated that each patient within the identified group of patients may be assigned a number associated therewith without revealing information that can be used to identify the patients' identity, in accordance with HIPAA. Therefore, information regarding patients' health may now be revealed to others, e.g., a researcher other than the treating physicians, because the information that can be used to identify the patients' identity has been removed.

According to one embodiment, the GUI may be used to identify one or more comparison factors. For example, a researcher may be interested in studying a distribution of Crohn's disease in various geographical locations. As such, various geographical locations, e.g., Los Angeles and San Francisco, may be identified as the comparison factors while the Crohn's disease is identified as the research criteria factor. In response to receiving the research criteria factors and further based on the comparison factors, distribution of patients with Crohn's disease in San Francisco versus those in Los Angeles is rendered on a display, e.g., as a pie chart, bar graph, etc., in compliance with HIPAA. It is appreciated that not specifying a comparison factor may, in one embodiment, provide every possible comparison for the identified group of patients, e.g., patients with Crohn's disease in different geographical location, patients with Crohn's disease distribution by race, by age, by gender, etc.

Accordingly, an automated clinical research is provided without inconveniencing patients. Moreover, an automated clinical research is provided while addressing patients' privacy concerns, e.g., in accordance with HIPAA and other regulatory protections. The automated clinical research further provides drug manufacturers with an effective marketing tool by enabling them to study the patient characteristics, thereby enabling them to improve their marketing campaign. Moreover, the automated clinical research enables drug manufacturers to study the effect of their drug, their efficacy, and possible side effects thereof without inconveniencing patients.

More particularly, a method of facilitating medical research is disclosed. The medical research method may include receiving at least one research criteria. It is appreciated that at least one comparison criteria may be received. It is appreciated that comparison criteria and/or at least one clinical research criteria may be selected from a group consisting of age, gender, race, geographical location, symptoms, diagnosis, laboratory value, treatment, insurance type, drug classification, and drug.

According to one embodiment, a database storing medical records associated with patients is accessed. It is appreciated that accessing the database may be in response to receiving the research criteria. According to one embodiment, the database is filtered based on at least one research criteria to identify a group of patients that satisfy at least one research criteria.

The information within medical records of the group of patients is processed to generate processed information operable for output, e.g., to a memory component, for transmission to a user, to render on a display, etc. The information that is processed is associated with the at least one comparison criteria. According to one embodiment, the processing includes statistical analysis of the group of patients based on the at least one comparison criteria. The result of the statistical analysis may be rendered by a display, e.g., in a pie chart. It is appreciated that the processed information may be stored in a memory component.

According to one embodiment, the processing includes purging confidential information associated with the group of patients according to health insurance portability and accountability act as well as other local regulatory requirements (hereinafter HIPAA). In one exemplary embodiment, each patient within the group of patients is assigned a number. Assignment of number may occur subsequent to the purging.

In one embodiment, a method of facilitating medical research includes accessing a database storing medical records associated with patients. The confidential information associated with the patients is purged according to health insurance portability and accountability act (HIPAA). The method further includes filtering the database based on at least one research criteria to identify a group of patients that satisfy at least one research criteria. In one exemplary embodiment, at least one research criteria is selected from a group consisting of age, gender, race, geographical location, symptoms, diagnosis, laboratory value, treatment, insurance type, drug classification, and drug. According to one embodiment, the group of patients is output for rendering by a display.

It is appreciated that the method may further include outputting medical information associated with a selected patient from the group of patients operable to be rendered by the display. According to one embodiment, the outputting is responsive to a selection of the selected patient and is substantially compliant with HIPAA.

According to one embodiment, the method includes outputting a specific medical information associated with the selected patient. The outputting may be responsive to a selection of the specific information operable to be rendered by the display and is substantially compliant with HIPAA.

In one embodiment, the medical information of the group of patients is processed based on at least one comparison factor to generate processed information. In one exemplary embodiment, at least one comparison factor is selected from a group consisting of age, gender, race, geographical location, symptoms, diagnosis, laboratory value, treatment, insurance type, drug classification, and drug. It is appreciated that the processed information is substantially compliant with HIPAA. The method further includes outputting the processed information operable to be rendered by the display.

According to one embodiment, the processing includes statistical analysis of the group of patients based on at least one comparison factor. It is appreciated that a number of patients associated with the group of patients may be adjustable based on a user selectable sample size.

In one alternative embodiment, a method of facilitating medical research includes receiving at least one research criteria. At least one clinical research criteria is selected from a group consisting of age, gender, race, geographical location, symptoms, diagnosis, laboratory value, treatment, insurance type, drug classification, and drug.

A database storing medical records associated with patients based on the at least one research criteria to identify a group of patients that satisfy at least one research criteria is filtered. It is appreciated that the filleting may be in response to the receiving of at least one research criteria. The method may further include processing information within medical records of the group of patients to generate processed information operable for output. The information is associated with at least one comparison criteria that is different from at least one research criteria.

According to one embodiment, the method includes generating at least one question to be answered by a patient or a doctor of the patient within the group of patients. The method may further include receiving answers to said at least one question. According, the processing of information may be further based on the answers.

It is further appreciated that the processing may further include purging confidential information associated with the group of patients according to health insurance portability and accountability act (HIPAA).

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 shows an exemplary on-line system in accordance with one embodiment of the present invention.

FIG. 2 shows an exemplary flow diagram associated with an automated clinical research study in accordance with one embodiment of the present invention.

FIG. 3 shows an exemplary flow diagram associated with an automated clinical research study in accordance with one embodiment of the present invention.

FIGS. 4A-4B show an exemplary graphical user interface associated with an electronic medical record in accordance with one embodiment of the present invention.

FIGS. 5A-5F show exemplary graphical user interface associated with receiving patient related information in accordance with embodiments of the present invention.

FIGS. 6A-6E show exemplary graphical user interface associated with an automated clinical research in accordance with embodiments of the present invention.

FIGS. 7A-7P show exemplary graphical user interface associated with performing an automated clinical research in accordance with embodiments of the present invention.

FIG. 8 shows an exemplary graphical user interface associated with social networking of physicians in accordance with one embodiment of the present invention.

FIGS. 9A-9D Show exemplary processed results associated with comparison factors in accordance with embodiments of the present invention are shown.

FIGS. 10A and 10B show an exemplary flow diagram associated with an automated clinical research c in accordance with one embodiment of the present invention.

FIG. 11 shows one exemplary flow diagram associated with an automated clinical research in accordance with one embodiment of the present invention.

FIG. 12 shows an exemplary flow diagram associated with an automated clinical research in accordance with one embodiment of the present invention.

FIG. 13 illustrates a general purpose computer system that may serve as a platform for embodiments of the present invention.

### DETAILED DESCRIPTION

Reference will now be made in detail to embodiments of the present invention, examples of which are illustrated in the accompanying drawings. While the invention will be described in conjunction with these embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be evident to one of ordinary skill in the art that the present invention may be practiced without these specific details. In other instances, well known methods, procedures, components, and circuits have not been described in detail as not to unnecessarily obscure aspects of the invention.

### Notation and Nomenclature

Some portions of the detailed descriptions which follow are presented in terms of procedures, steps, logic blocks, processing, and other symbolic representations of operations on data bits that can be performed on computer memory. These descriptions and representations are the means used by those skilled in the art to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities.

Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “creating” or “generating” or “filtering” or “purging” or “assigning” or “transferring” or “executing” or “determining” or “instructing” or “issuing” or “displaying” or “outputting” or “storing” or “changing” or “accessing” or “adding” or “obtaining” or “selecting” or “receiving” or “transmitting” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

### A Method and System for Facilitating Clinical Research

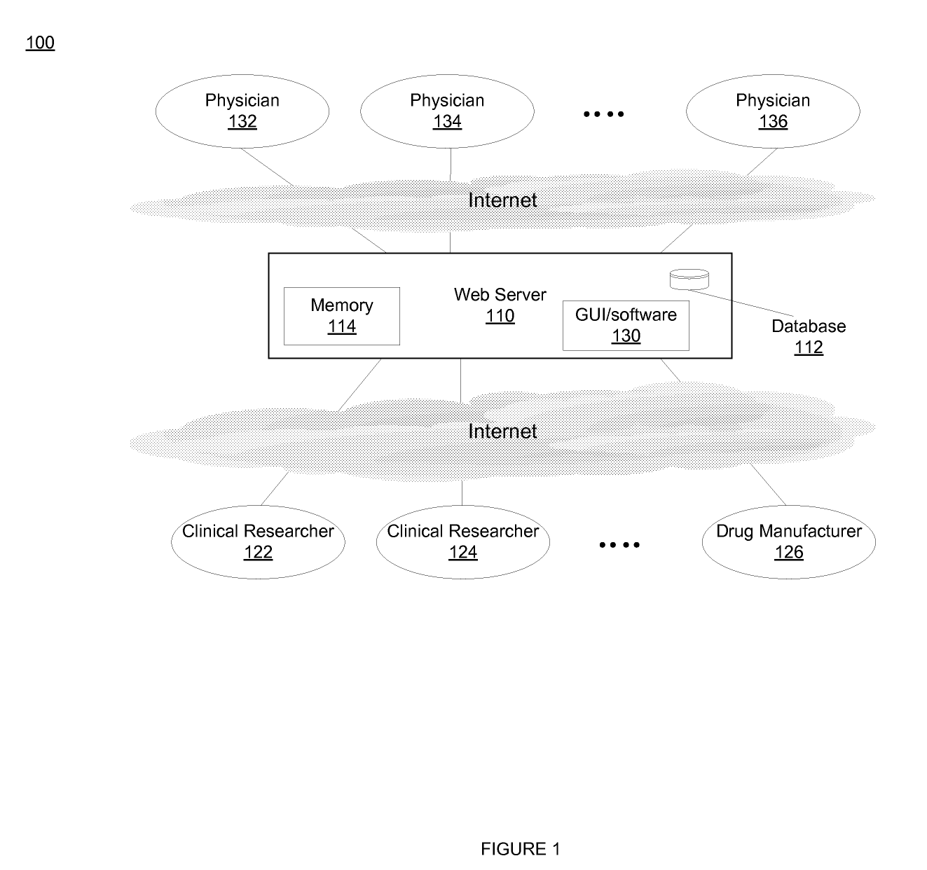

Referring to FIG. 1, an exemplary on-line system 100 in accordance with one embodiment of the present invention is shown. The exemplary system 100 includes a plurality of terminals associated with physicians 132, 134, and 136, a plurality of terminals associated with clinical researchers 122, and 124, and a terminal associated with a drug manufacturer 126, and a web server 110 coupled therewith. The plurality of clinical researchers, the plurality of physicians, and the drug manufacturer may be coupled to the web server 110 via the Internet, for instance, thus creating the on-line system. It is appreciated that a computer used by a physician may serve as the web server 110. It is appreciated that the web server 110 may be a remote server used to store patient related information, e.g., electronic medical record. Moreover, it is appreciated that one or more of the terminals may be wirelessly coupled. For example, a terminal may be a portable electronic device.

Various examples provided throughout this application are related to post market clinical research. However, it is appreciated that the present invention is not limited thereto and is equally applicable to premarket clinical research, epidemiologic research, public health research, etc. It is further appreciated, that the embodiments of the present invention may be used for prospective clinical research as well as retrospective clinical research. Prospective clinical research refers to clinical studies that are designed in advance and information associated with the designed prospective clinical study is collected and subsequent thereto is processed and analyzed. Retrospective clinical research refers to clinical studies where already collected information is processed and analyzed. It is appreciated that embodiments provided herein are exemplary and not intended to limit the scope of the present invention.

As described in more detail to follow, the website or server 110 includes software 130 for creating a GUI, in accordance with embodiments of the present invention. The server 110 may further include a memory component 114 and may further be coupled to a database 112. The database 112 may store patient related information, e.g., electronic medical record.

It is appreciated that the software 130 may alternatively reside in each terminal, e.g., physicians 132-136, clinical researchers 122, and 124, and the drug manufacturer 126. It is appreciated, that in one embodiment, patients may be asked to consent to their health information be shared with entities other than the treating physician in accordance with health insurance portability and accountability act (HIPAA). It is appreciated that patients may choose to opt-out from sharing their health information with others. However, health information associated with patients that choose not to opt-out may be shared with others in accordance with HIPAA.

According to embodiments of the present invention, the software 130 enables physicians and/or clinical researchers and/or drug manufacturers to perform clinical research study in an automated fashion in compliance with HIPAA. In one embodiment, a number of patients enrolled in a clinical research study may be tracked by a program associated with the GUI and a treating physician associated therewith may be rewarded accordingly. It is appreciated, that the reward base program may be based on different factors, e.g., type of disease being studied, number of patients enrolled, type of drug being studied, and specific contract with a medical practice, etc.

The GUI may be used to facilitate interactions with a data bank of patient information stored in a server. For example, the GUI may be used to send/receive specific information associated with clinical research, e.g., to study a particular drug, drug classification, drug-drug interactions, drug efficacy, drug safety, disease prevalence, disease incidence, disease control, disease prevention, prognosis, disease outcome as well as population base outcomes (e.g., based on demographics, race, ethnicity, etc.), patient characteristics, demographical study, marketing of drugs, and selection of subjects for new prospective studies for a new drug clinical trial based on predefined questions, etc.

Collection and processing of large scale health information is advantageous in understanding a drug and its effect on the disease that it treats. Understanding the drug and its effect on the disease based on large scale health information may enable the treating physician to personalize a treatment to a given patient based on various factors, e.g., race, age, gender, patient condition, other diagnosis, etc. As such, large scale collection and processing of health information brings medical/scientific community closer to achieving personalized and customized health care for each patient.

According to one embodiment, physicians 132-136, clinical researchers 122-124, and/or the drug manufacturer 126 use the GUI to enter or select one or more research criteria. Research criteria is used to identify a group of patients that satisfy a specific criteria, e.g., a specific drug, drug classification, age group, race, gender, geographical location, etc. For example, research criteria may be used to identify a group of patients from the patient related information stored in the database 112. In other words, the research criteria may be used to identify a subset of patients stored in the database 112.

According to one embodiment, a list of patients within the identified group of patients may be rendered to the physician treating the patients without removing any confidential information. For example, the name, address, social security, etc., associated with a patient within the identified group of patients is not removed as long as the information is being rendered and accessed by the physician treating the patient.

On the other hand, the confidential information associated with the patients, e.g., name, address, social security, etc., is removed prior to rendering the list of patients to a researcher other than the physician treating the patient. It is appreciated that each patient may be associated with a number instead of the confidential information. Thus, it is appreciated that the confidential information associated with a patient is removed prior to its display to a researcher other than the treating physician in order to comply with HIPAA or local regulatory bodies. In general, HIPAA requires that information specific to a patient that can be used to identify the identity of a patient should be removed prior to its rendition to a party other than the treating physician in order to protect patient's privacy.

The list of patients within the identified group may be rendered in accordance with HIPAA. For example, a list of patients within the identified group may be transmitted to the requesting party for rendition. A selection of a specific patient within the identified group may provide additional information associated with that patient. For example, a research criteria may be to identify patients with a specific diagnosis, e.g., Crohn's disease. Thus, a subset of patients stored in the database 112 that have been diagnosed with Crohn's disease is identified.

The list of identified patients is returned to the requesting party in accordance with HIPAA. The requesting party may further select one or more of the patients with Crohn's disease to obtain additional information. A selection of a patient with Crohn's disease may further cause the database 112 to provide additional information regarding the selected patient while not providing patients identifying information in accordance with HIPAA regulations. For example, the additional information may reveal that the selected patient with Crohn's disease has been further diagnosed with Spondylitis disease.

According to one embodiment, the requesting party may further specify one or more comparison factors. For example, the researcher may be interested in studying the distribution of Crohn's disease in different races. As such, the comparison factors associated with different races may include Blacks, Hispanics, Caucasians, Asians, Middle Eastern, etc. Accordingly, the identified group of patients may be divided into various races by determining a race of each patient within the identified group. It is appreciated that the race of each patient may be determined by accessing the patient related information stored in the database 112. For example, each medical record associated with a patient may include a race of the patient and accessing the medical record stored in the database 112 enables the race of the patient to be determined automatically.

Accordingly, an automated clinical research is provided without inconveniencing patients by facilitating patient related information via a GUI, wherein the information is provided in compliance with HIPAA. The GUI interactions with the database storing patient information further enables physicians, researchers, drug manufacturers, etc., to study various factors of their interest without inconveniencing the patients and further without jeopardizing patients' privacy by providing information thereto in accordance with HIPAA. As such, various information stored in patients' medical record and patients' characteristics may be studied in order determine drug efficacy, adverse events (side effects) thereof, etc., without inconveniencing patients, and to further utilize that information to improve marketing as well as safety of various prescription drugs.

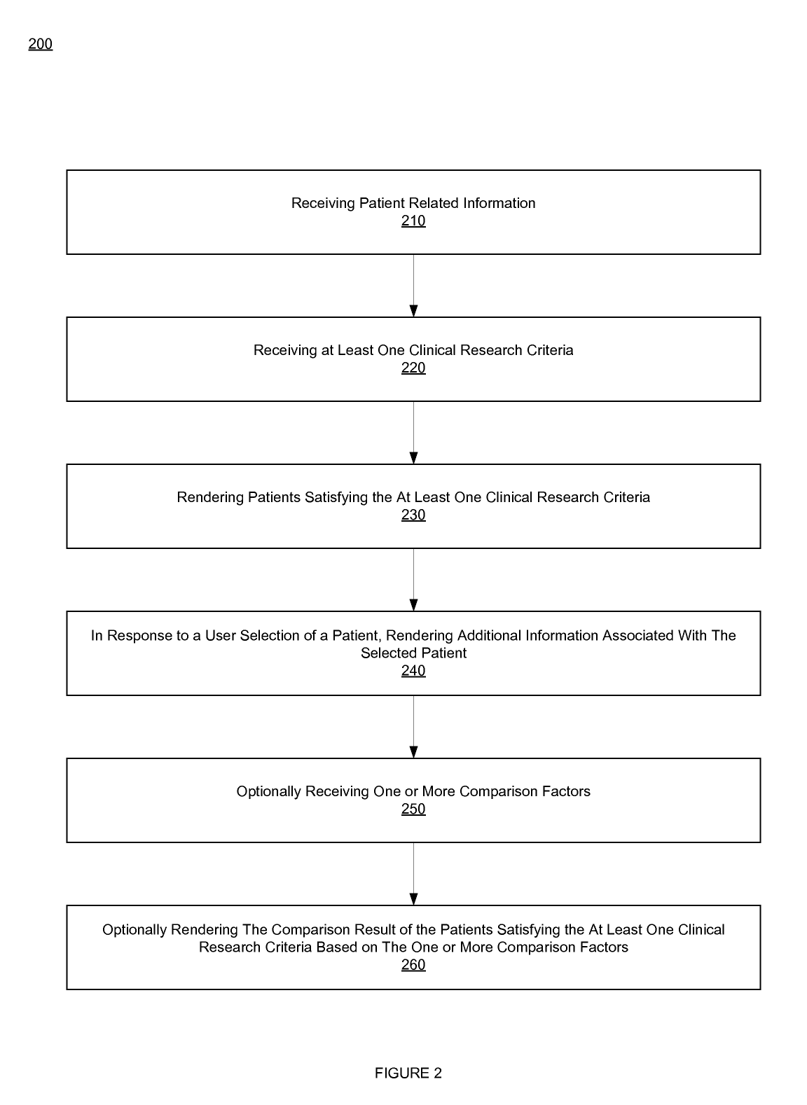

Referring now to FIG. 2, an exemplary flow diagram 200 associated with an automated clinical research study in accordance with one embodiment of the present invention is shown. At step 210, patient related information is received. Patient related information may include patient's name, address, age, race, sex, diagnosis, treatment, prescribed drug, physical exam, laboratory test, etc., or any combination thereof. It is appreciated that an electronic medical record may be used to receive patient related information. According to one embodiment, the received patient related information may be stored in a memory component, e.g., database 112.

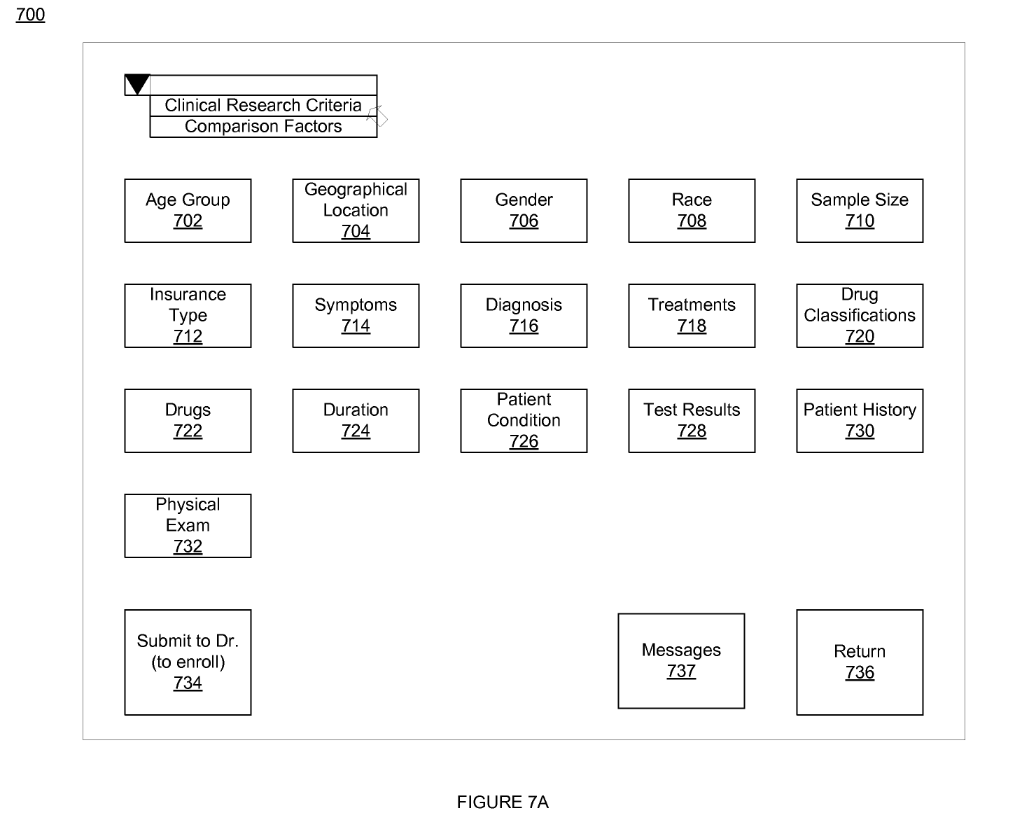

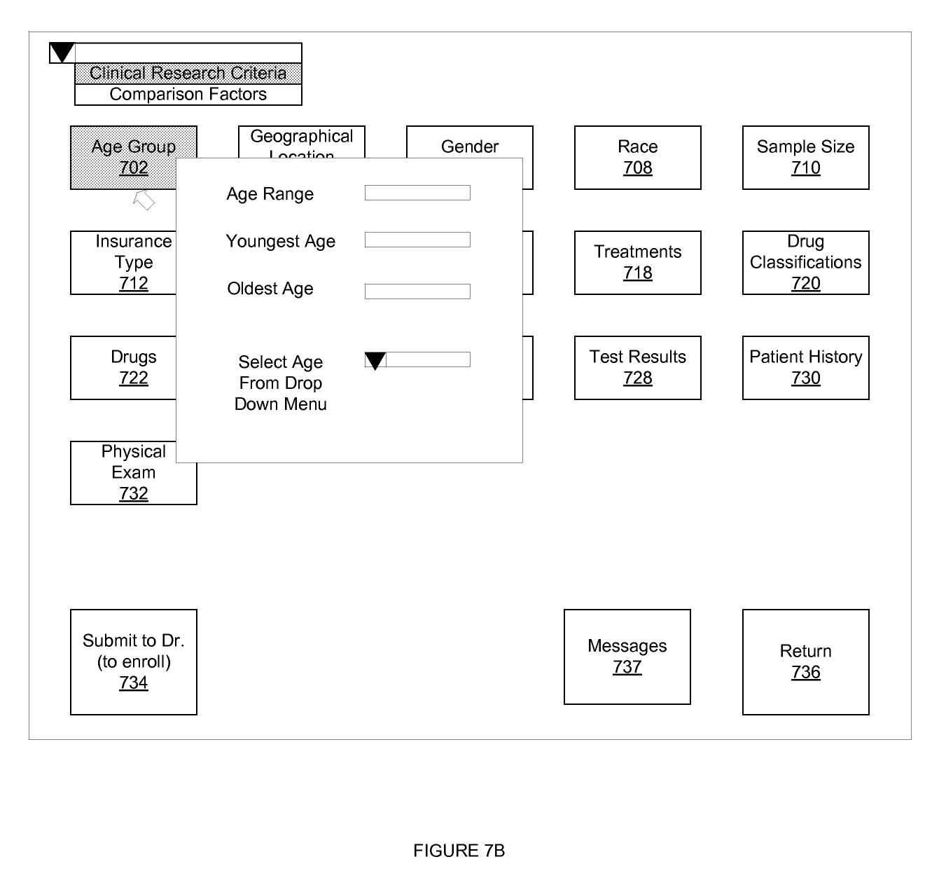

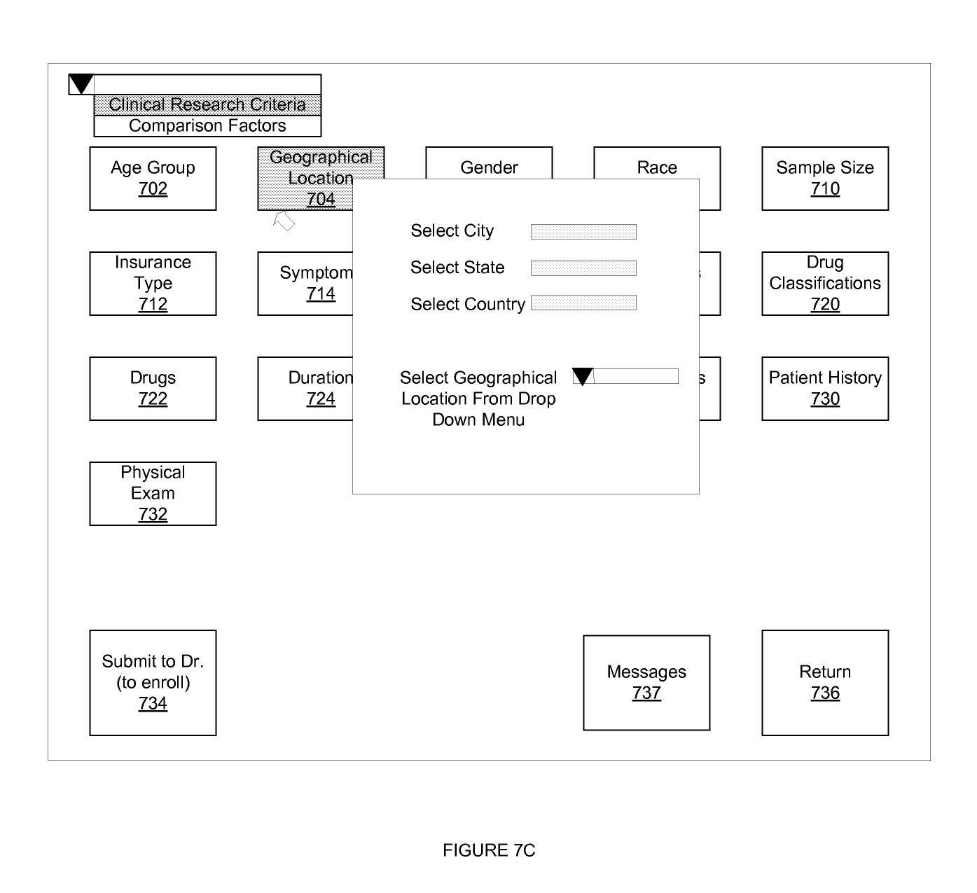

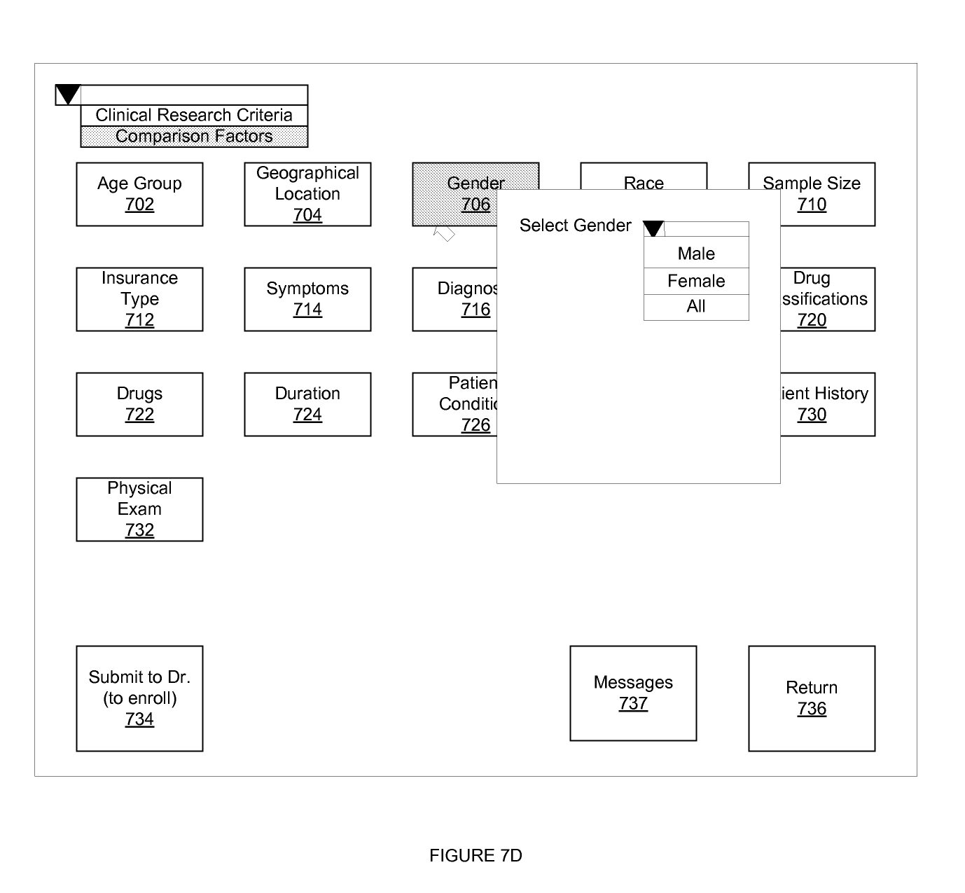

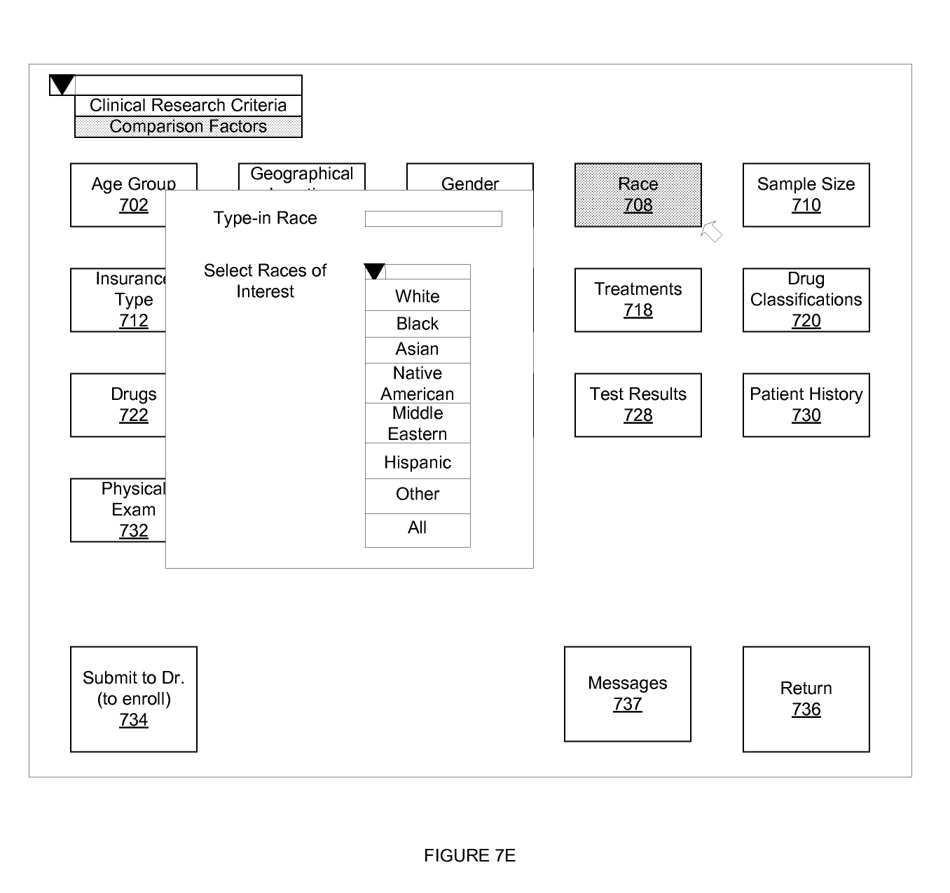

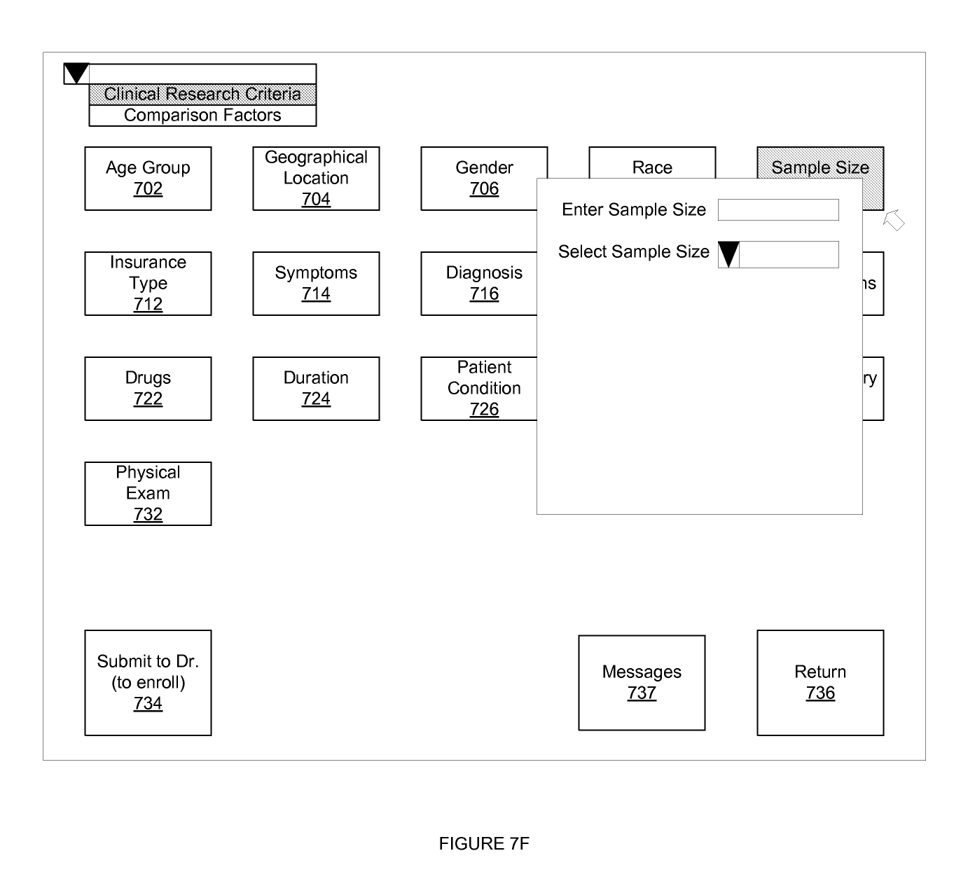

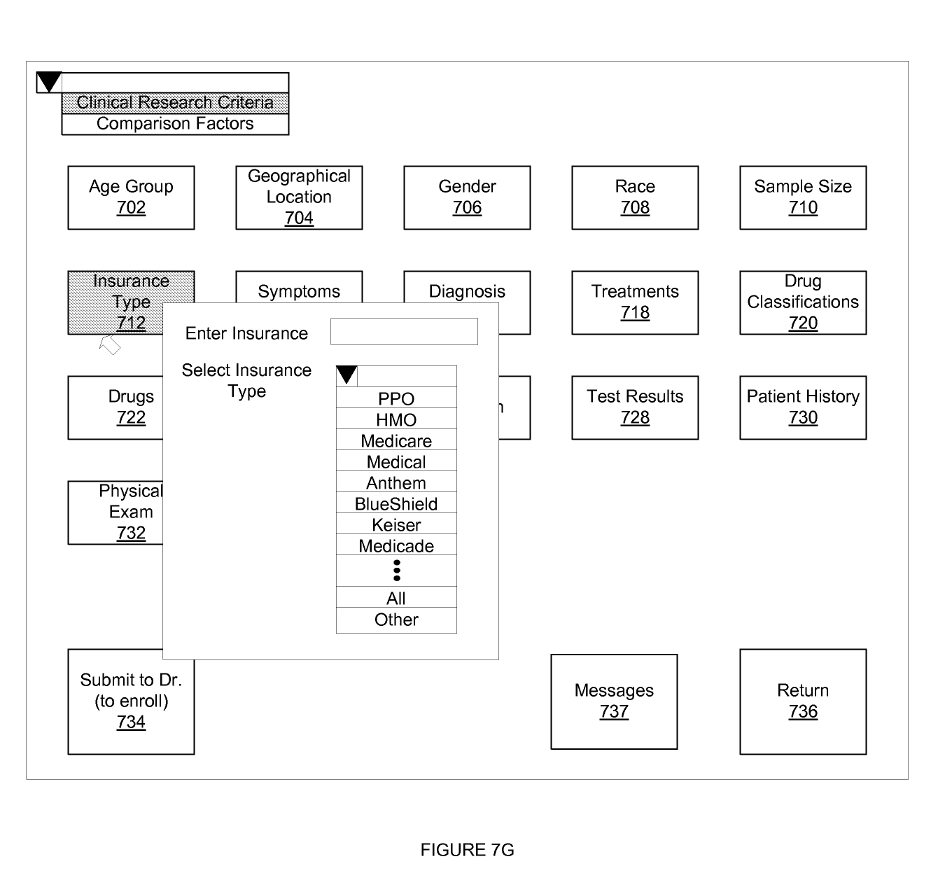

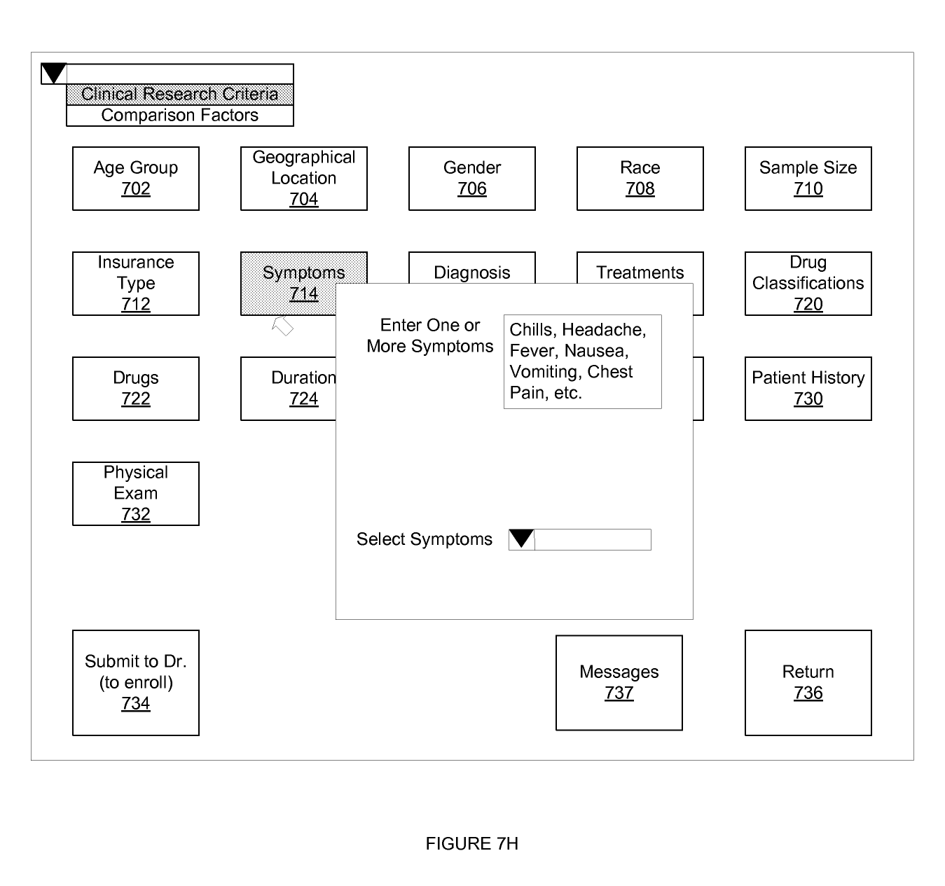

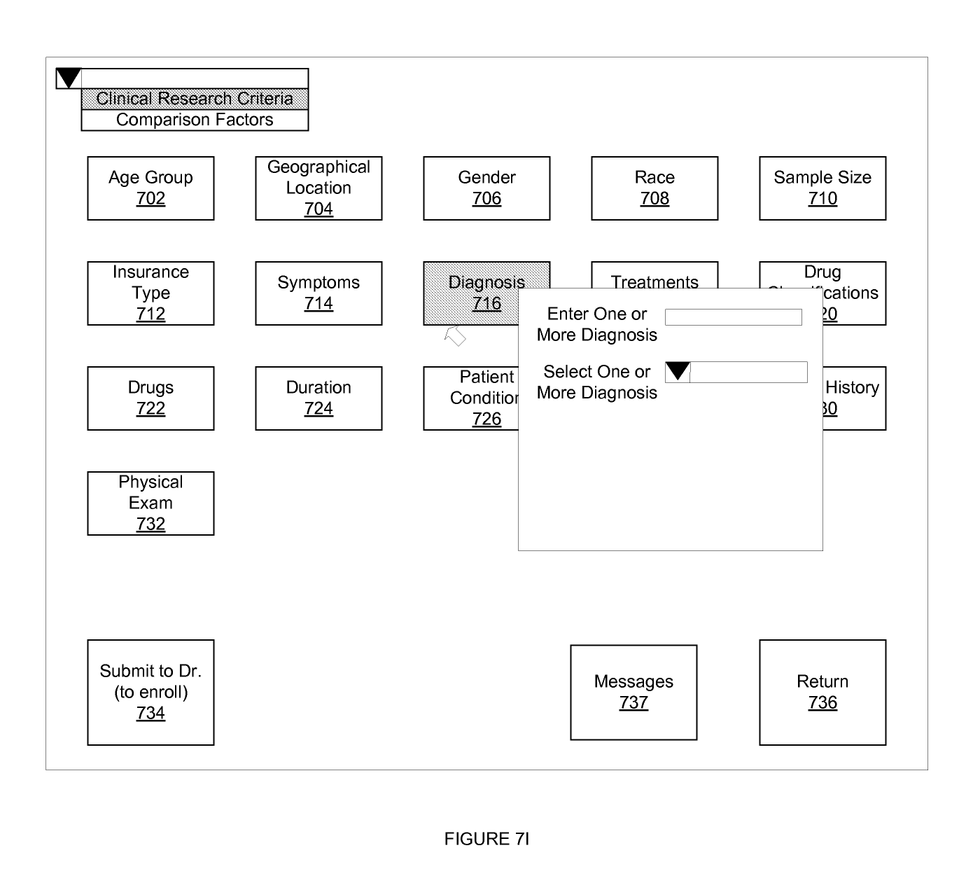

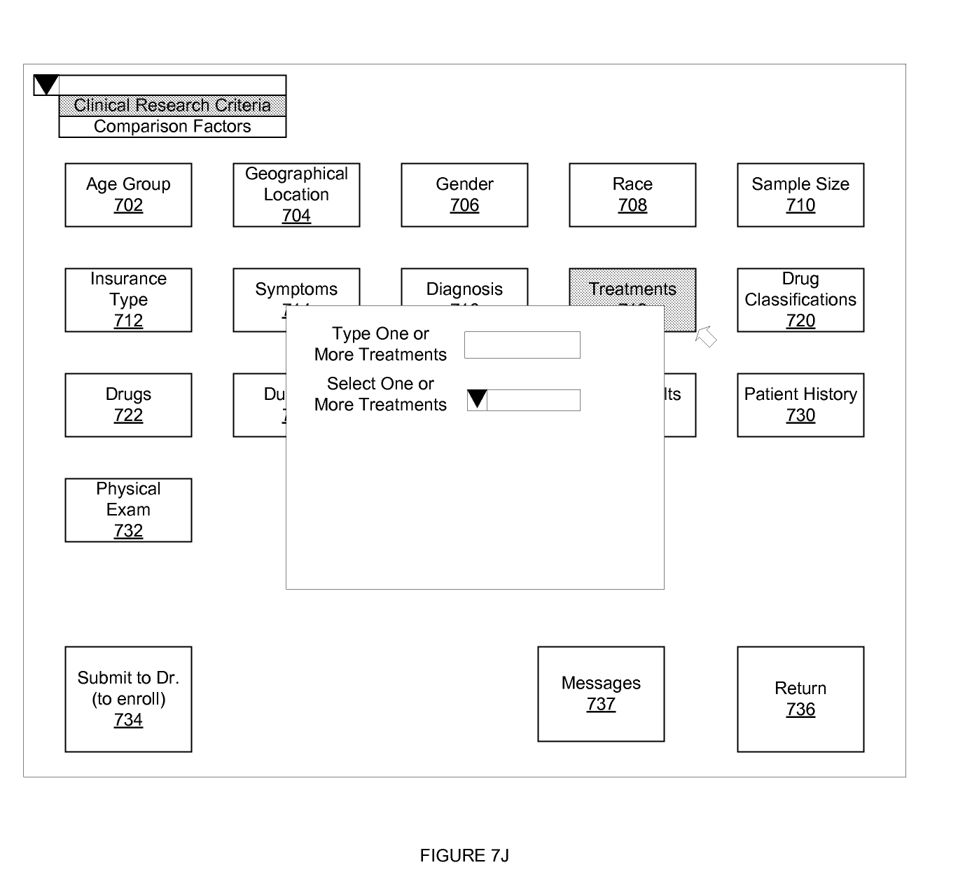

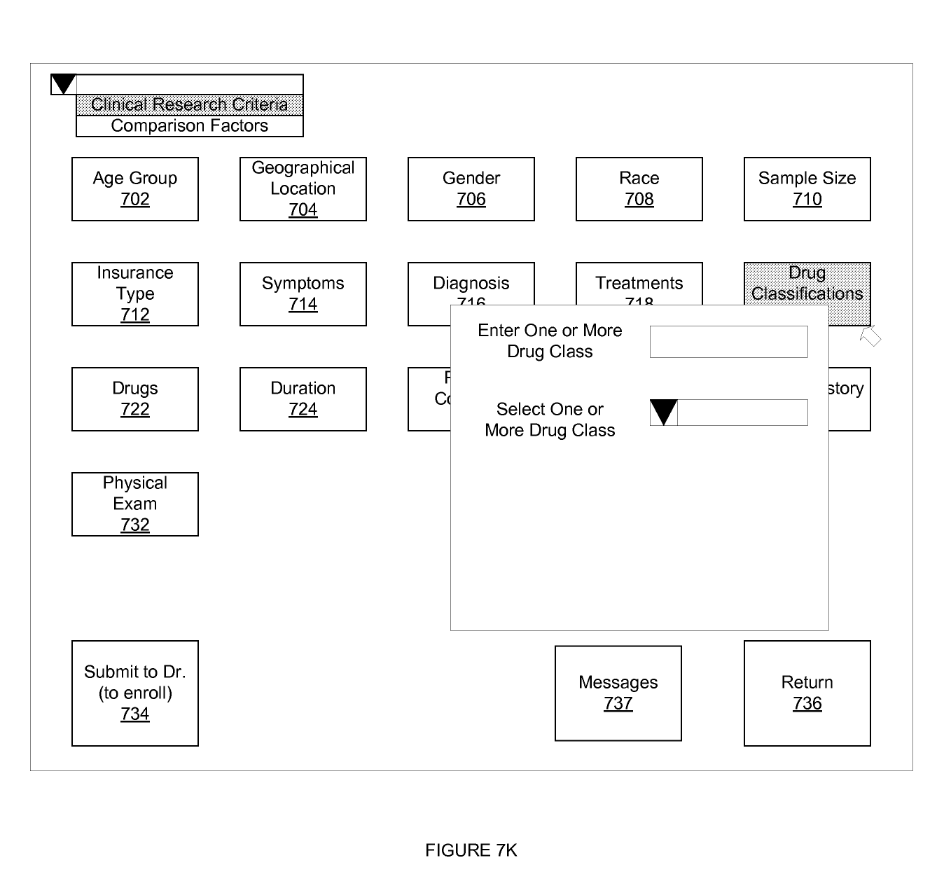

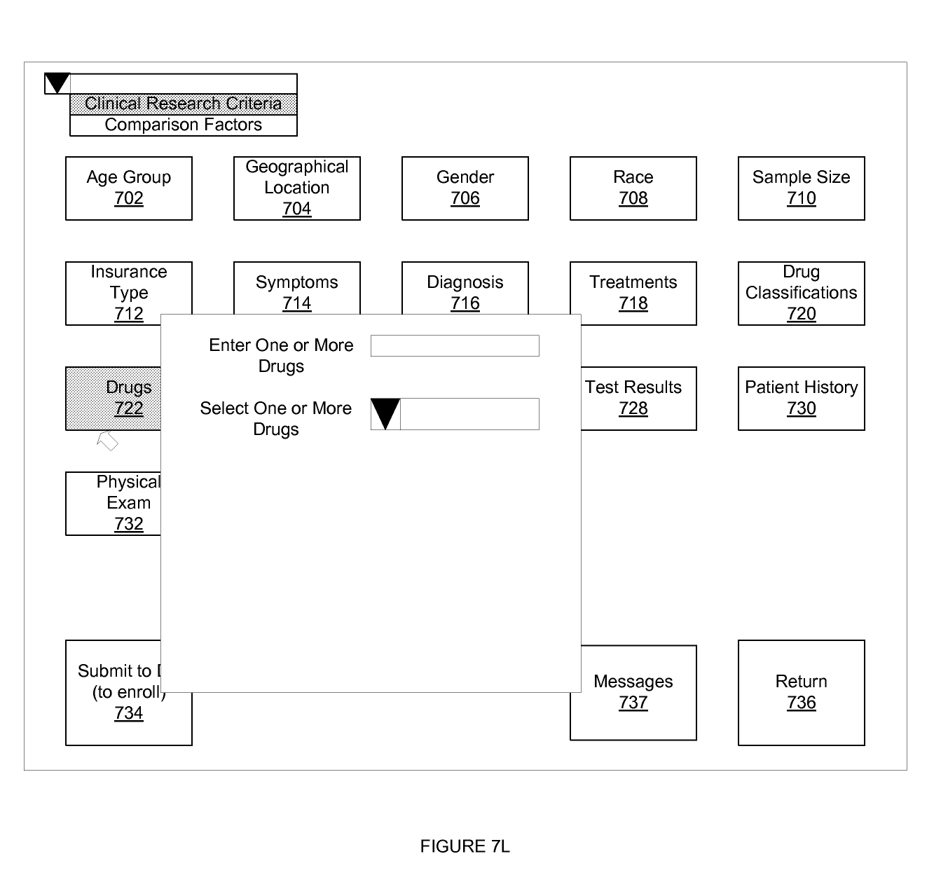

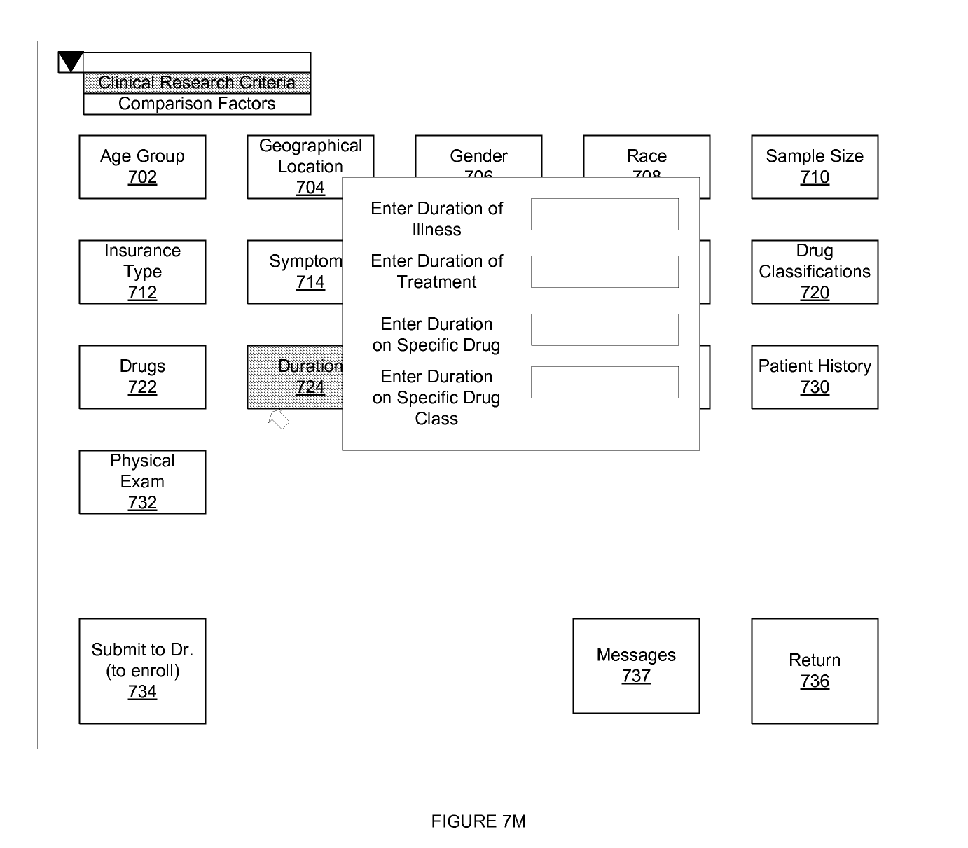

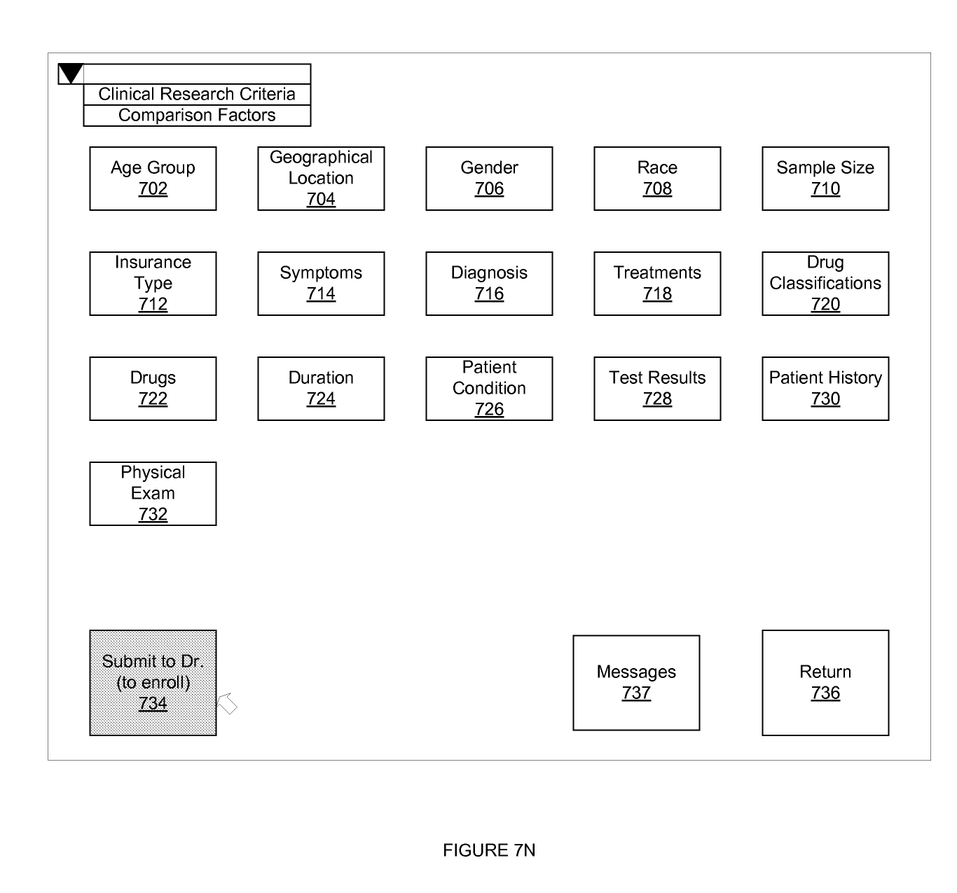

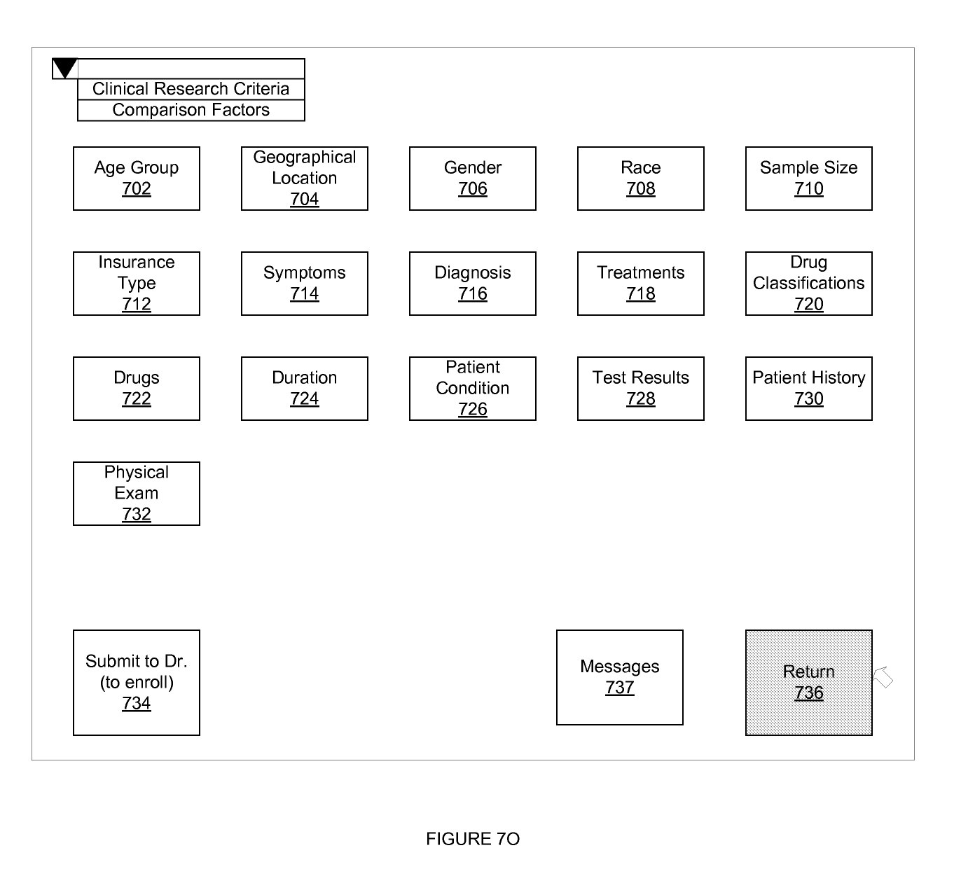

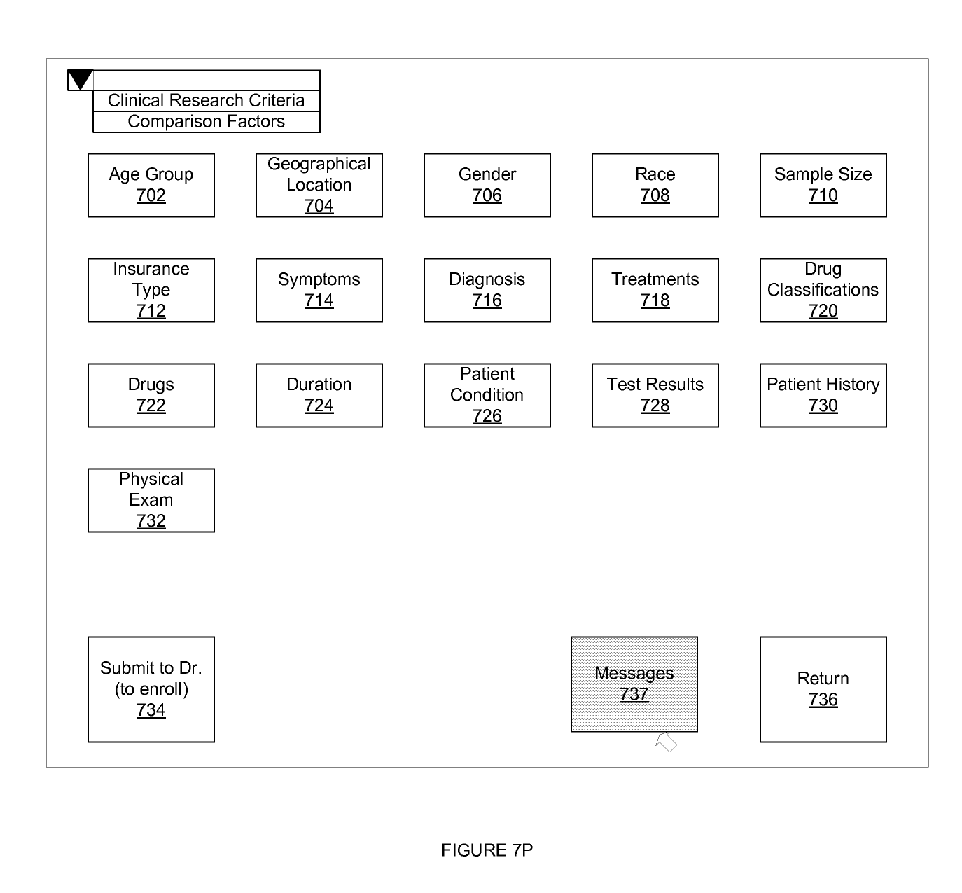

At step 220, one or more clinical research criteria may be received from a physician treating the patients. Clinical research criteria may be any criteria of interest, e.g., a particular drug, drug classification, diagnosis, treatment, age, sex, race, etc. It is appreciated that a more exhaustive list of clinical research criteria is discussed with respect to FIGS. 7A-7P. In this exemplary embodiment, the clinical research criteria may be male patients that have been diagnosed with Crohn's disease for more than 5 years that are between the ages of 25-35.

The memory component storing the electronic medical records may be scanned based on the received clinical research criteria. Accordingly, patients that satisfy the clinical research criteria may be identified. As such, a group of patients that satisfy the clinical research criteria is formed and identified. For example, a group of male patients between the ages of 25-35 that have been diagnosed with Crohn's disease for more than 5 years is identified.

At step 230, a list of patients associated with the group of patients that satisfy the received clinical research criteria is rendered. For example, the list of patients associated with the group of patients may be rendered by a display of the treating physician. It is appreciated that the rendered information may contain confidential and private information associated with each patient. However, the information rendered is protected by doctor-patient confidentiality and HIPAA regulations.

The list of patients rendered is user selectable. At step 240, a patient may be selected from the list and additional information regarding the selected patient is retrieved from the storage medium, e.g., database 112, and displayed to the physician. For example, selecting the ninth patient on the list of male patients within the ages of 25-35 that have been diagnosed with Crohn's disease for more than 5 years may reveal that the ninth patient has also been diagnosed with Spondylitis for less than 3 years.

At step 250, one or more comparison factors may be optionally received. The comparison factors are factors to compare the patients within the identified group with. For example, comparison factors may identify patients from the identified list that have Spondylitis disease versus those that have colon cancer.

Comparison factors may be any factor of interest, e.g., a particular drug, drug classification, diagnosis, treatment, age, sex, race, etc. It is appreciated that a more exhaustive list of comparison factors is discussed with respect to FIGS. 7A-7P.

At step 260, the result of the comparison associated with patients satisfying the received clinical research criteria is optionally rendered. For example, the comparison result may display the distribution and comparison of male patients within the ages of 25-35 that have been diagnosed with Crohn's disease for more than 5 years that also have Spondylitis versus those that have been diagnosed with colon cancer.

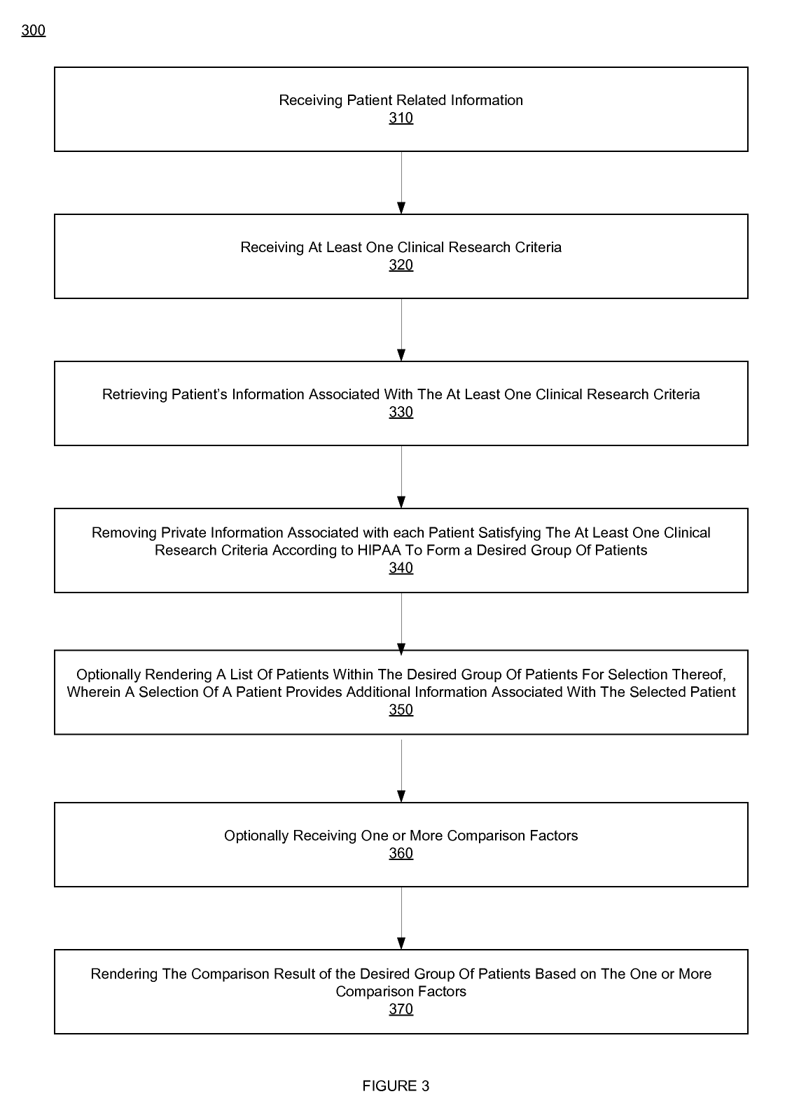

Referring now to FIG. 3, an exemplary flow diagram 300 associated with an automated clinical research study in accordance with one embodiment of the present invention is shown. At step 310, patient related information is received. Patient related information may include patient's name, address, age, race, sex, diagnosis, treatment, prescribed drug, physical exam, laboratory test, etc. It is appreciated that an electronic medical record may be used to receive patient related information. According to one embodiment, the received patient related information may be stored in a memory component, e.g., database 112.

At step 320, one or more clinical research criteria may be received from an entity other than the treating physician. Clinical research criteria may be any criteria of interest, e.g., a particular drug, drug classification, diagnosis, treatment, age, sex, race, etc. It is appreciated that a more exhaustive list of clinical research criteria is discussed with respect to FIGS. 7A-7P. In this exemplary embodiment, the clinical research criteria may be male patients that have been diagnosed with Crohn's disease for more than 5 years that are between the ages of 25-35.

The memory component storing the electronic medical records may be scanned based on the received clinical research criteria. Accordingly, patients that satisfy the clinical research criteria may be identified. As such, a group of patients that satisfy the clinical research criteria is formed. For example, a group of male patients between the ages of 25-35 that have been diagnosed with Crohn's disease for more than 5 years is identified.

At step 330, information associated with patients within the identified group of patients is retrieved from a storage component, e.g., database 112. For example, the information may include the name, address, date of birth, social security number, credit card number, additional diagnoses, additional treatments, prescription drugs, laboratory results, X-ray results, etc.

It is appreciated that entities other than the treating physician may not be privy to private and confidential information associated with patients in accordance with HIPAA. For example, patients' name, address, date of birth, social security number, etc., may not be revealed in order to protect patients' identity, and privacy and further to comply with the requirements of HIPAA and other regulatory restrictions.

Accordingly, at step 340, private and confidential information associated with patients within the identified group of patients is removed according to HIPAA. For example, information that can be used to identify the identity of the patients within the identified group of patients is removed. Thus, a desired group of patients is formed where confidential and private information associated with patients within the desired group of patients is removed in order to comply with the requirements of HIPAA.

At step 350, a list of selectable patients associated with the desired group of patients that satisfy the received clinical research criteria is rendered. The list of selectable patients is user selectable. Selection of a patient from the list causes additional information associated with the selected patient to be retrieved from the storage medium, e.g., database 112, and to further be rendered. For example, selecting the ninth patient on the list of male patients within the ages of 25-35 that have been diagnosed with Crohn's disease for more than 5 years may reveal that the ninth patient has also been diagnosed with Spondylitis for less than 3 years. It is appreciated that additional information rendered is in compliance with HIPAA. In other words, confidential and private information associated with the selected patient is not revealed to entities other than the treating physician.

Optionally at step 360, one or more comparison factors may be received. The comparison factors are factors to compare the patients within the list. For example, comparison factors may be to identify patients from the list that have Spondylitis disease versus those that have colon cancer. Comparison factors may be any factor of interest, e.g., a particular drug, drug classification, diagnosis, treatment, age, sex, race, laboratory value, etc. It is appreciated that a more exhaustive list of comparison factors is discussed with respect to FIGS. 7A-7P.

At step 370, the comparison results of desired group of patients based on the received comparison factors is optionally rendered. For example, the comparison result may display the distribution and comparison of male patients within the ages of 25-35 that have been diagnosed with Crohn's disease for more than 5 years that also have Spondylitis versus those that have been diagnosed with colon cancer.

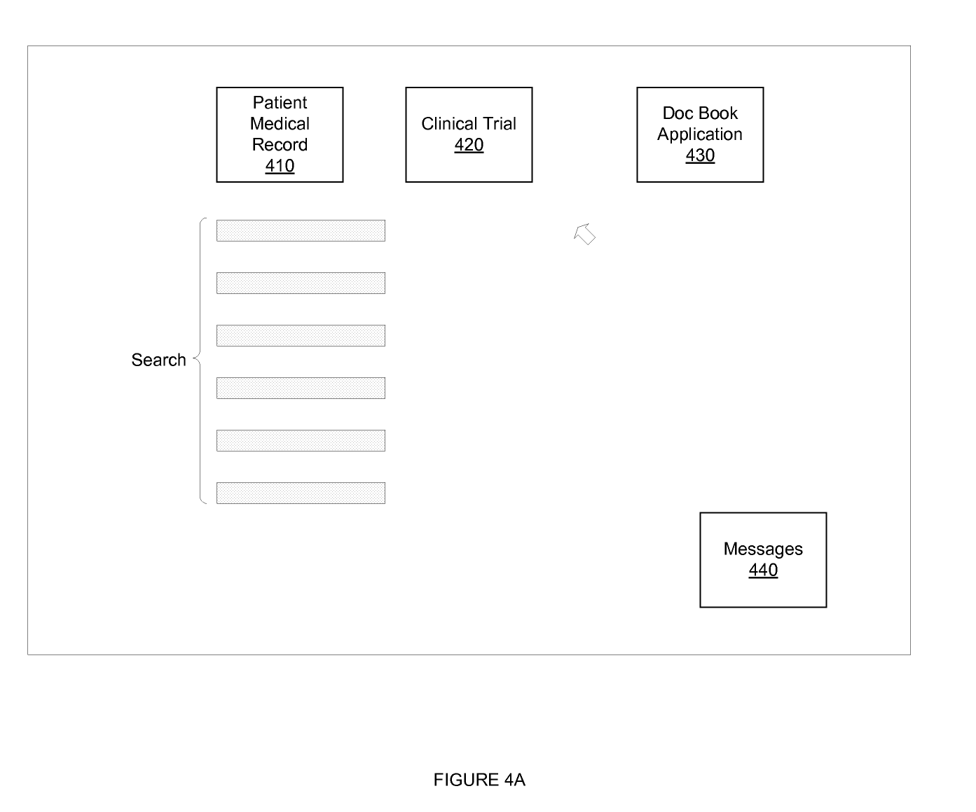

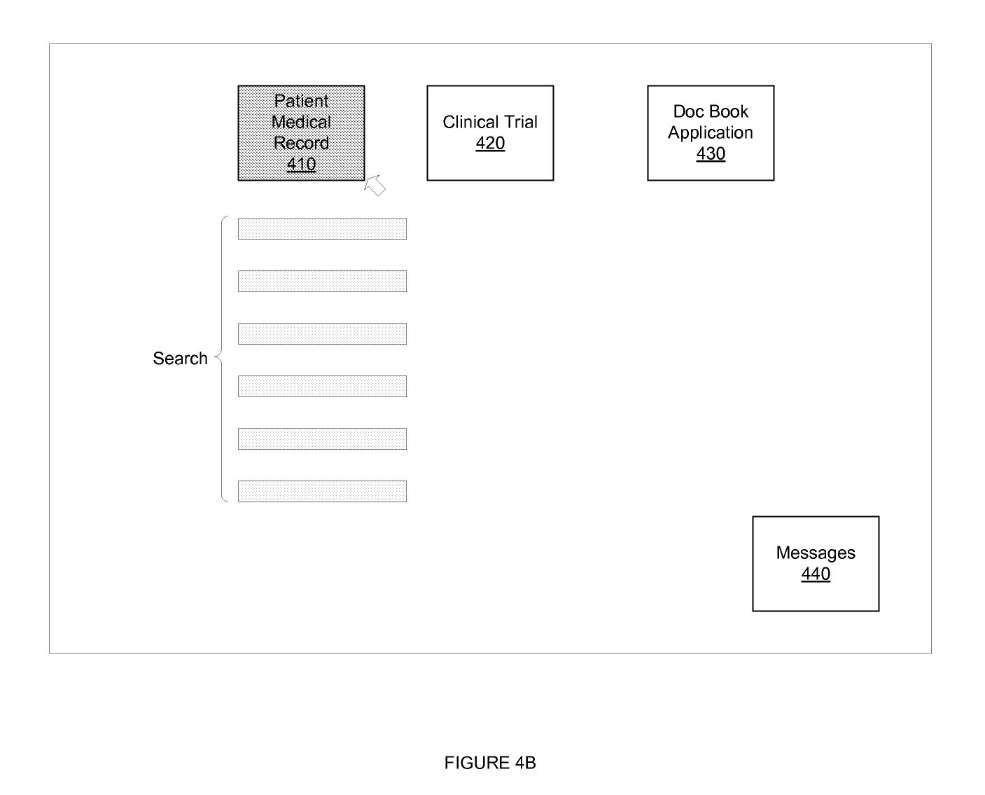

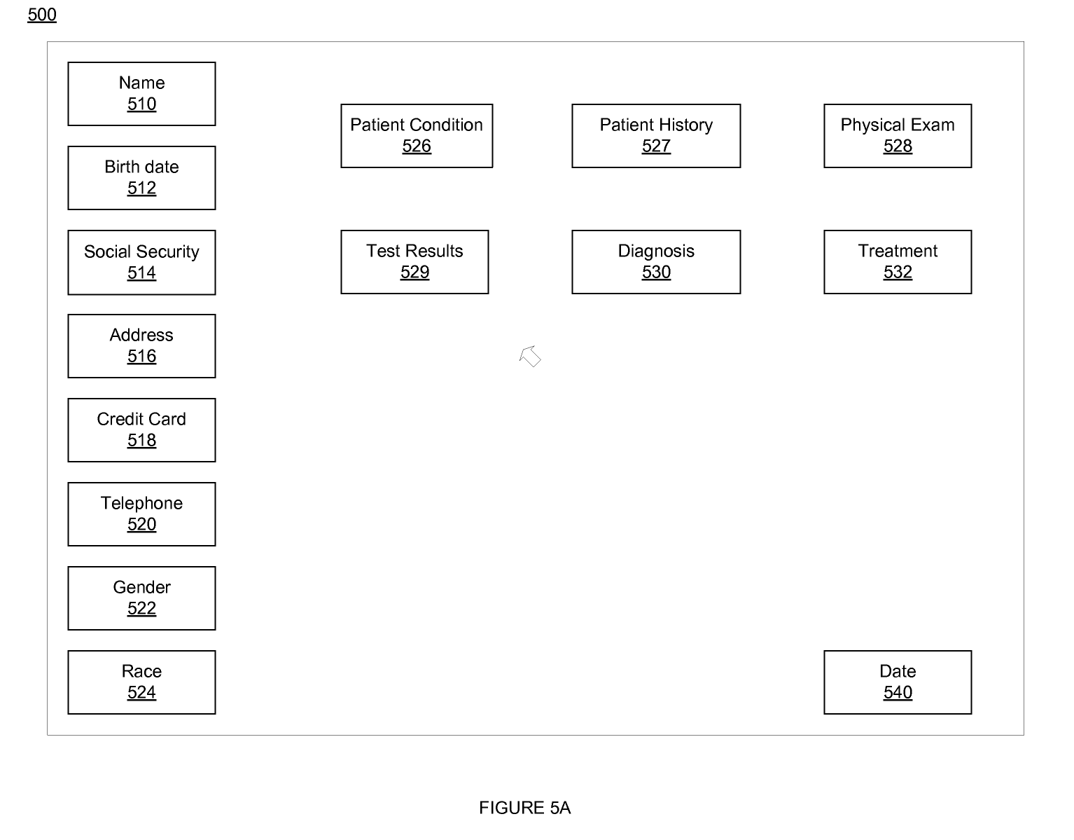

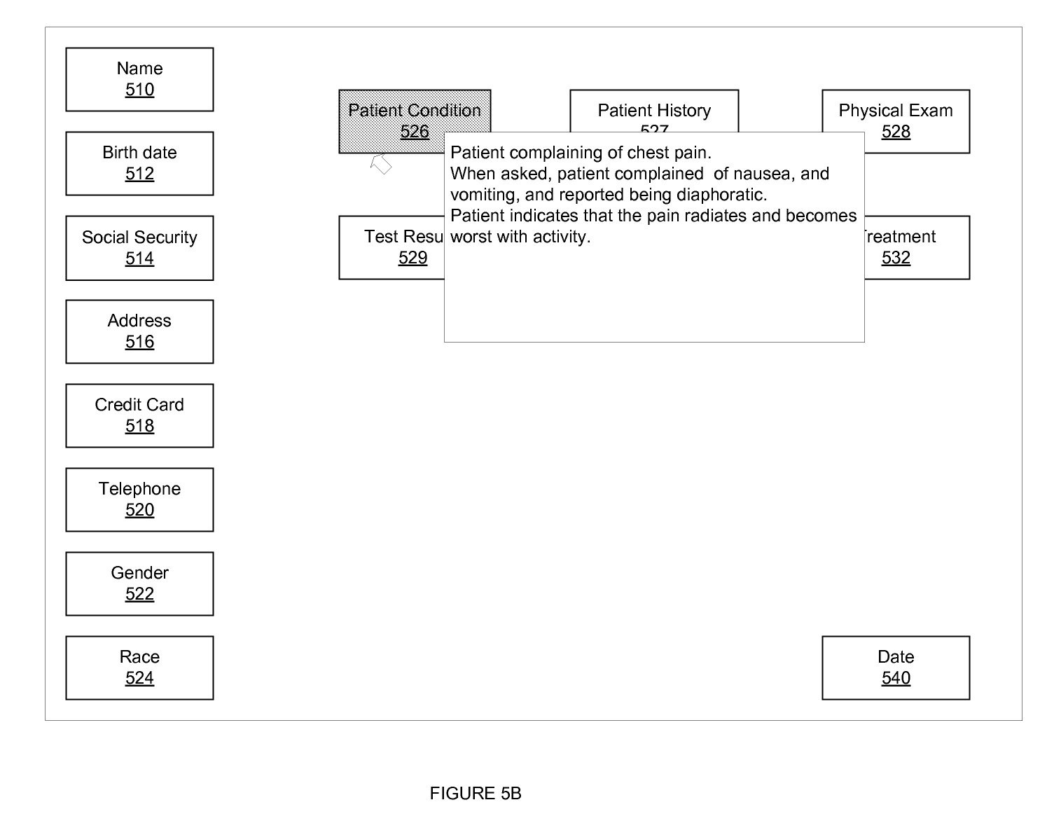

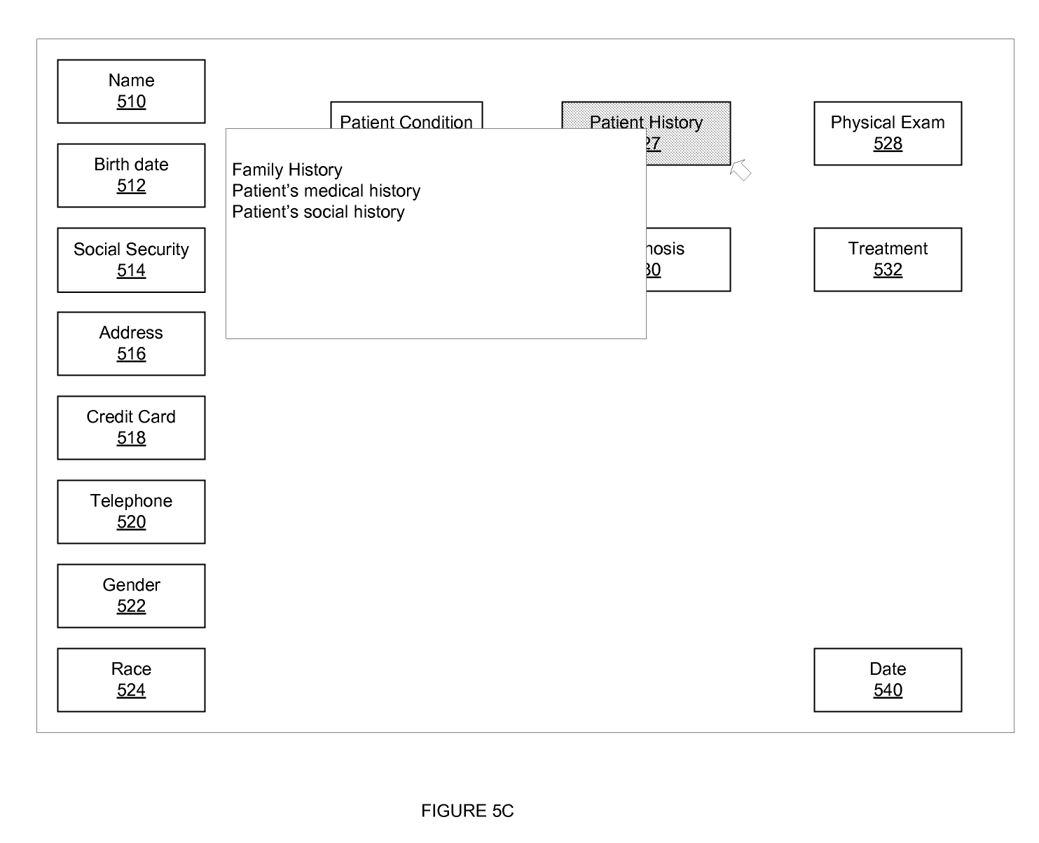

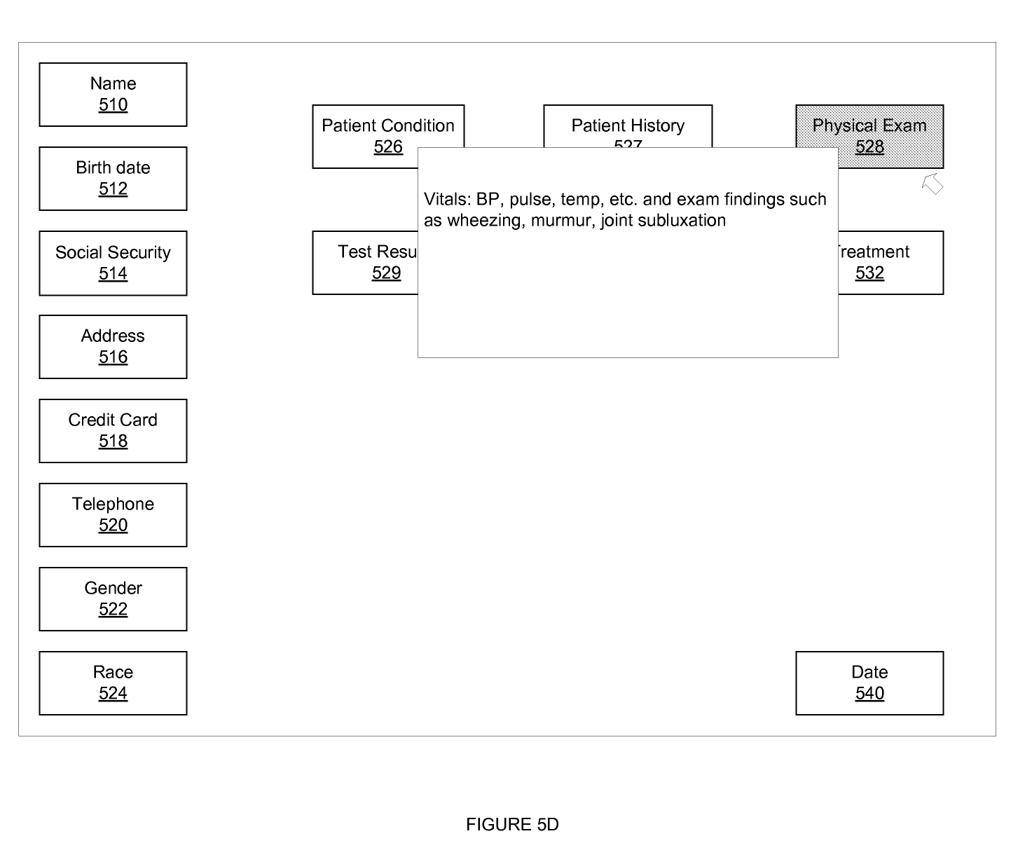

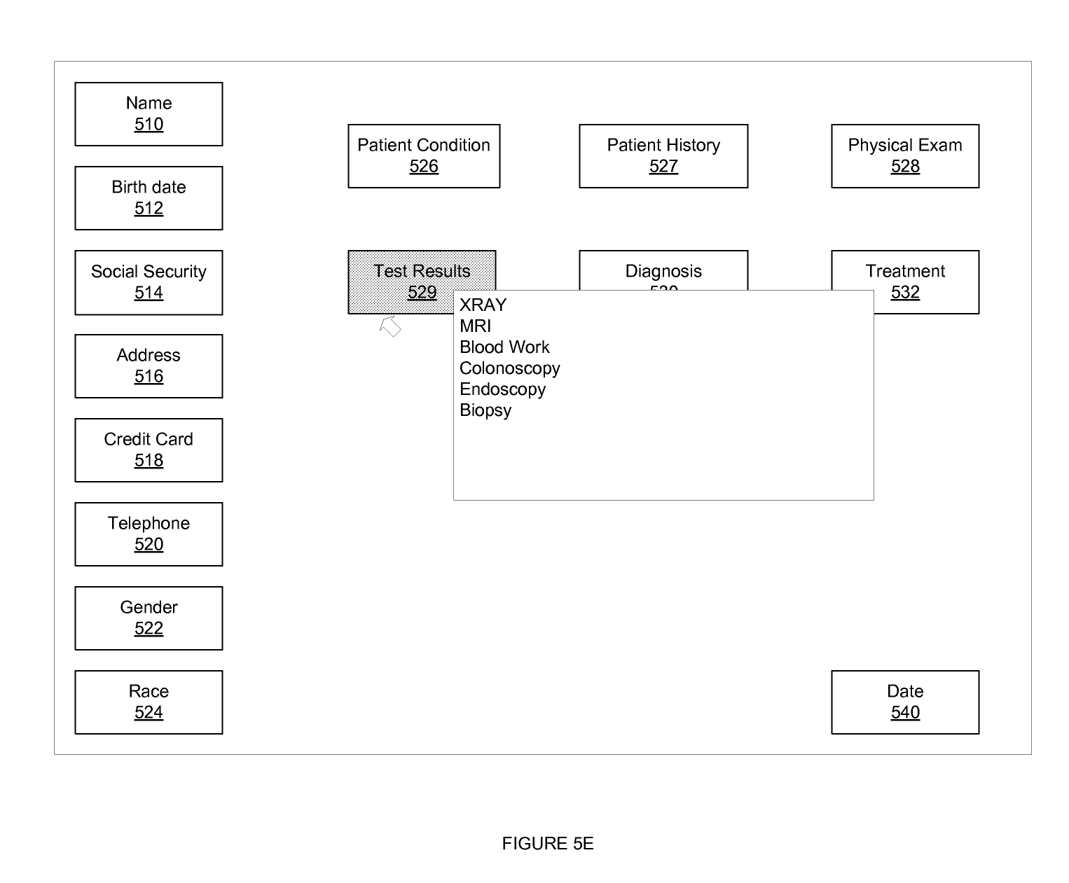

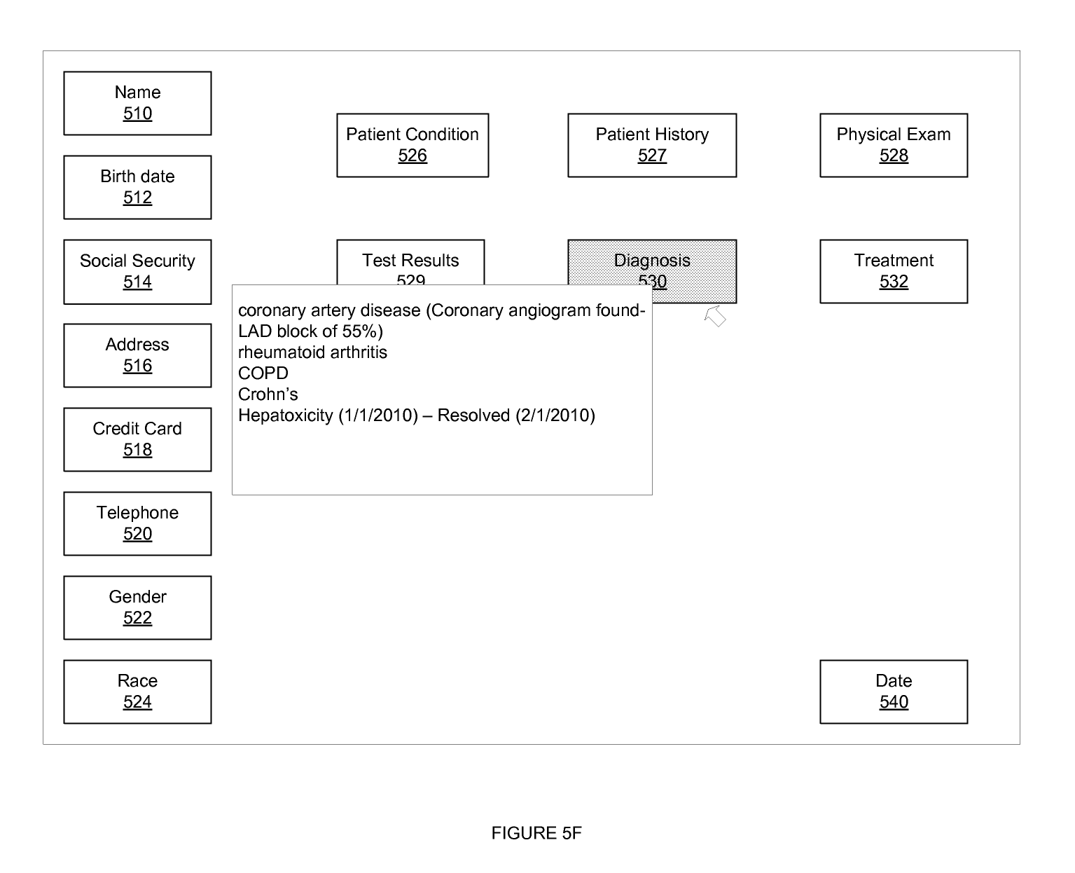

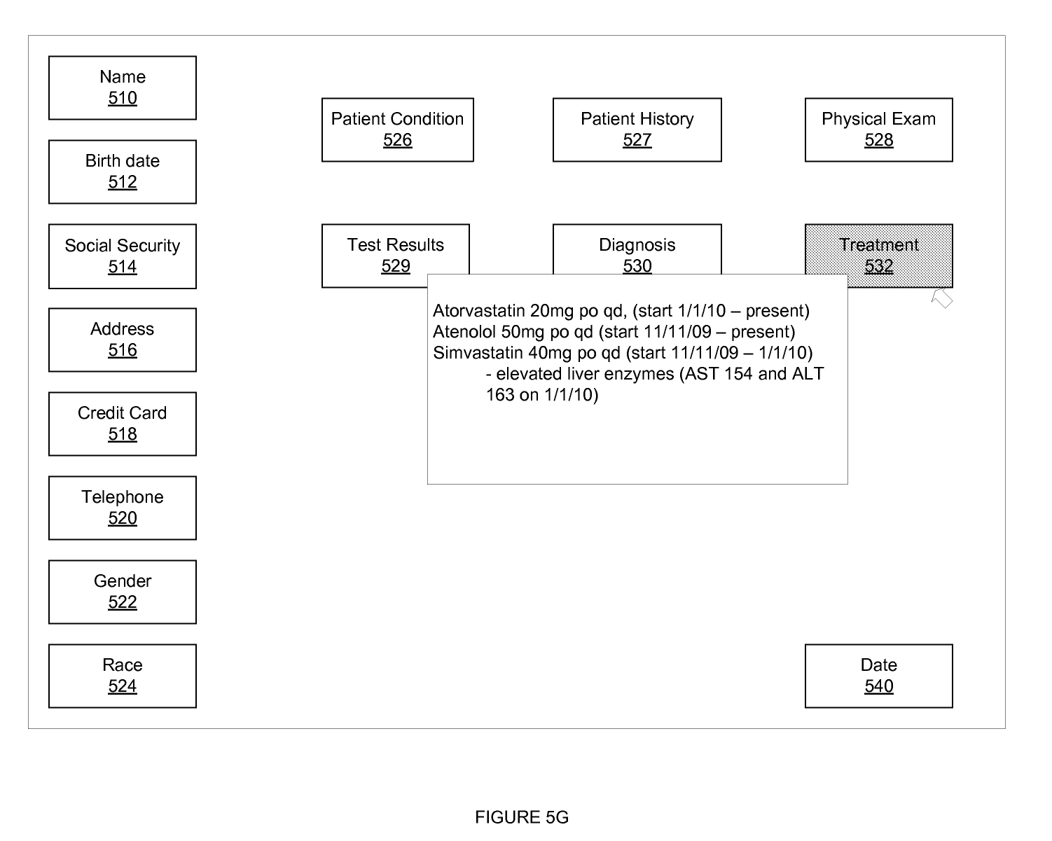

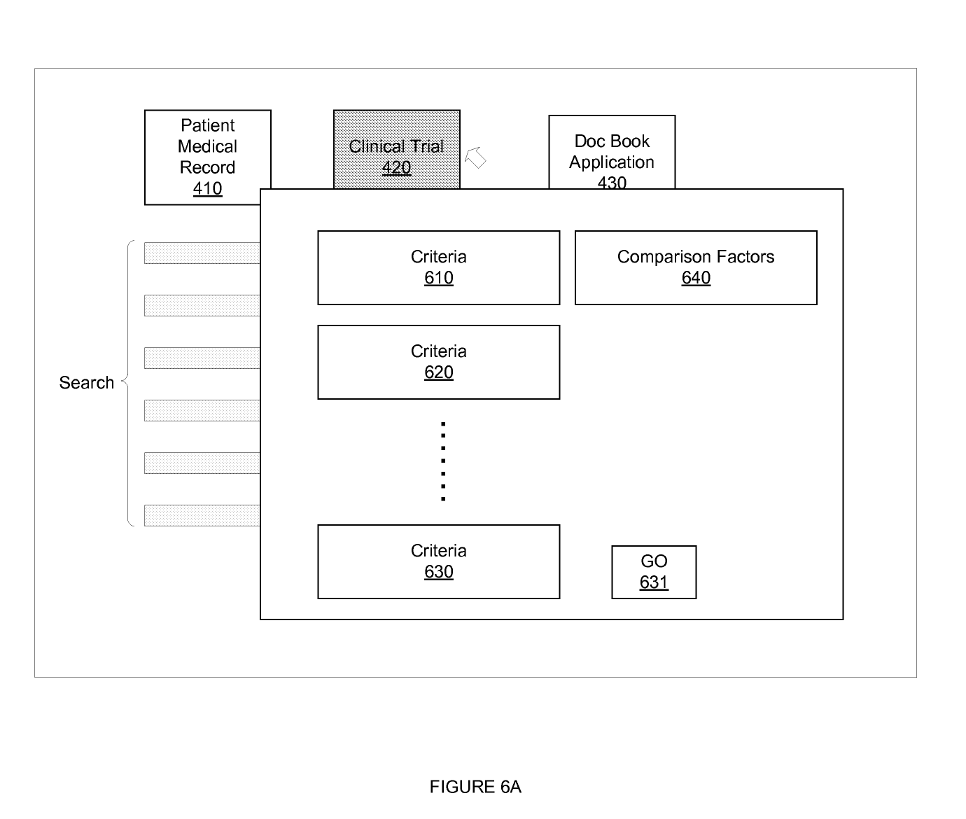

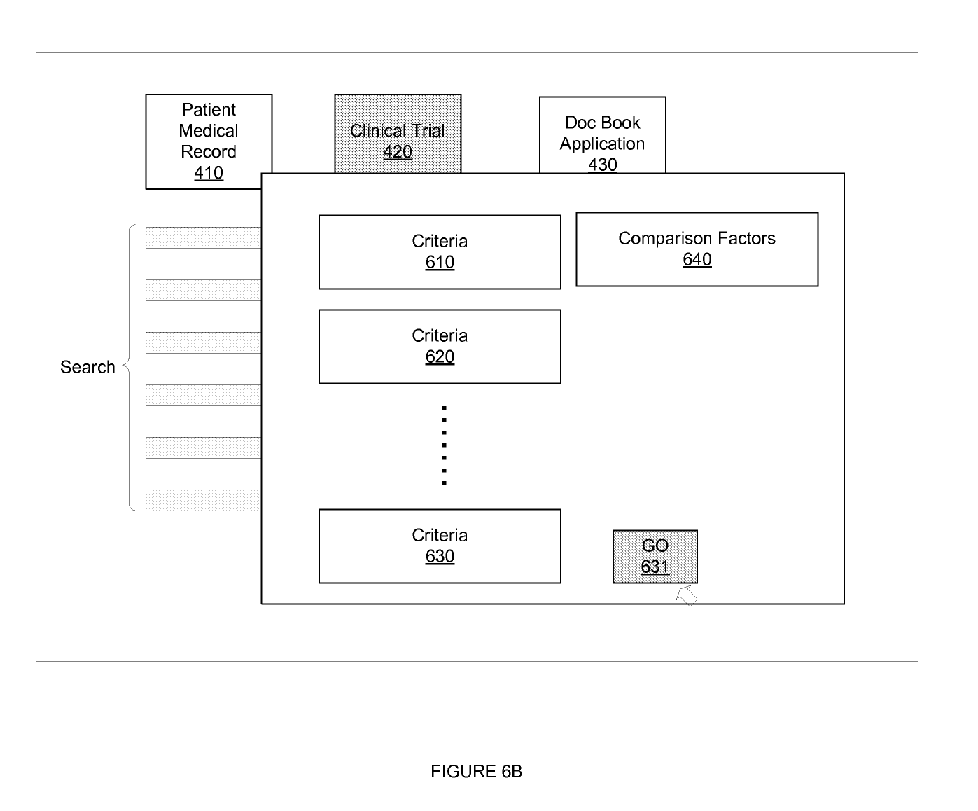

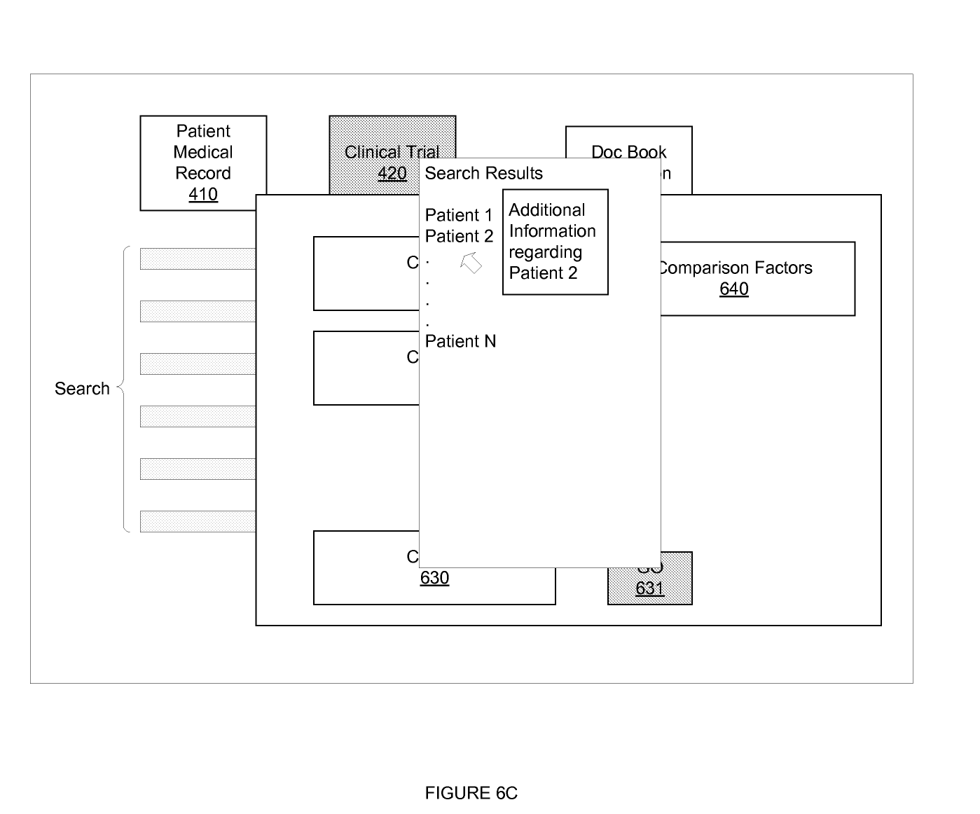

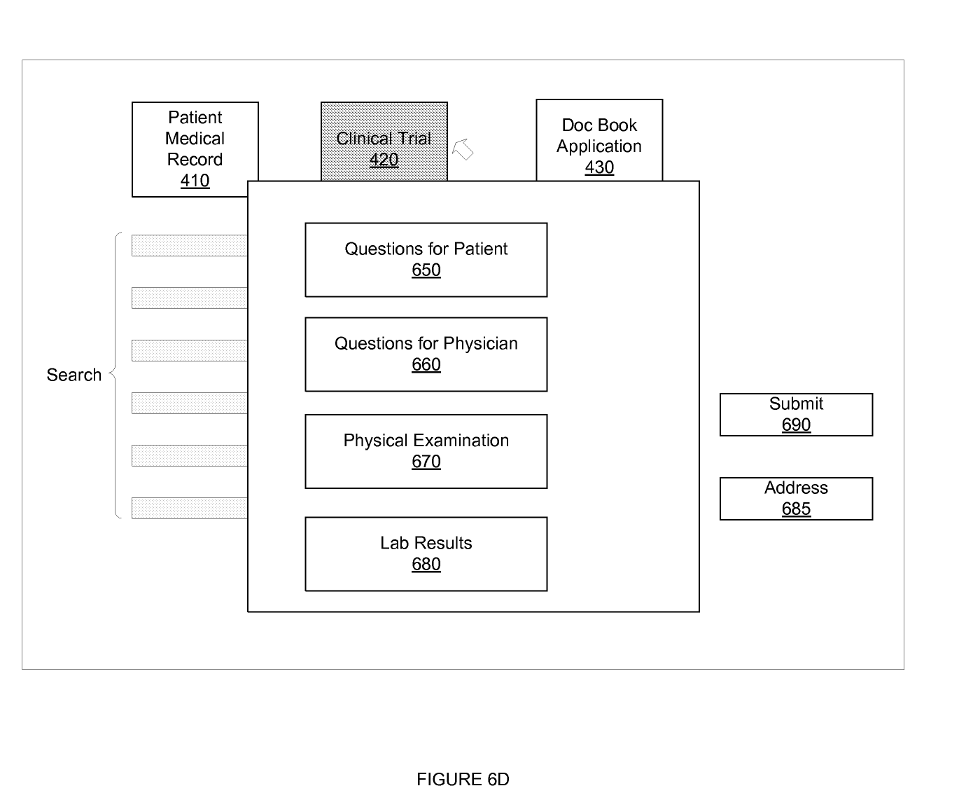

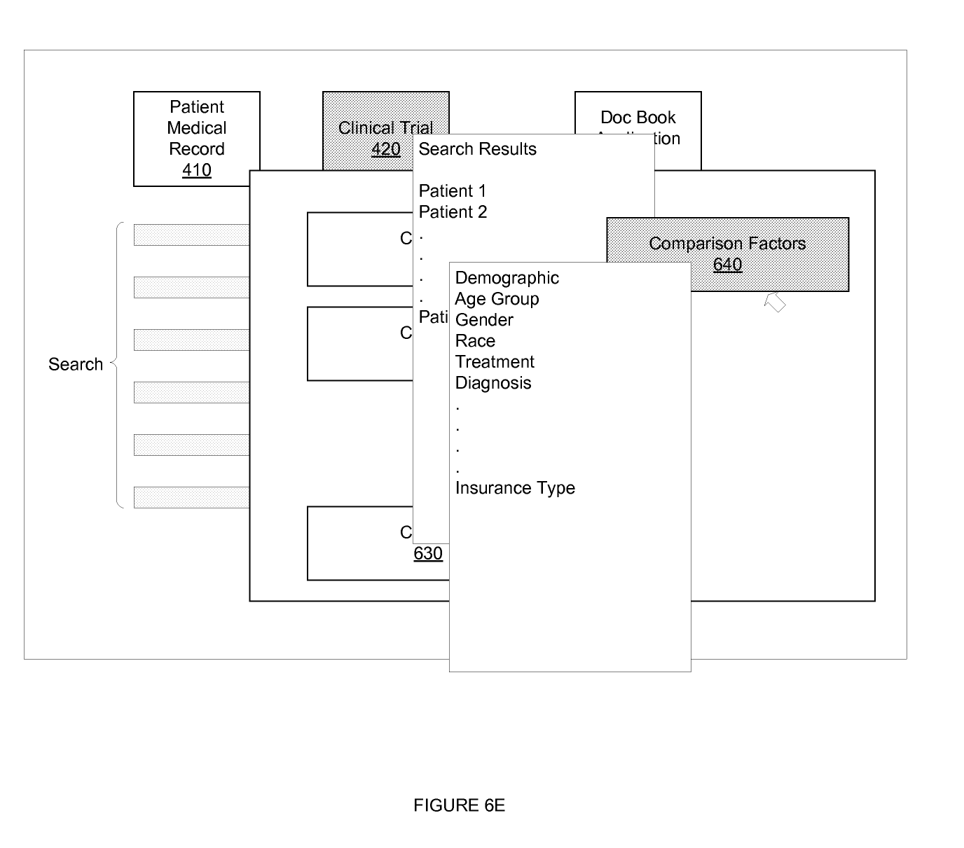

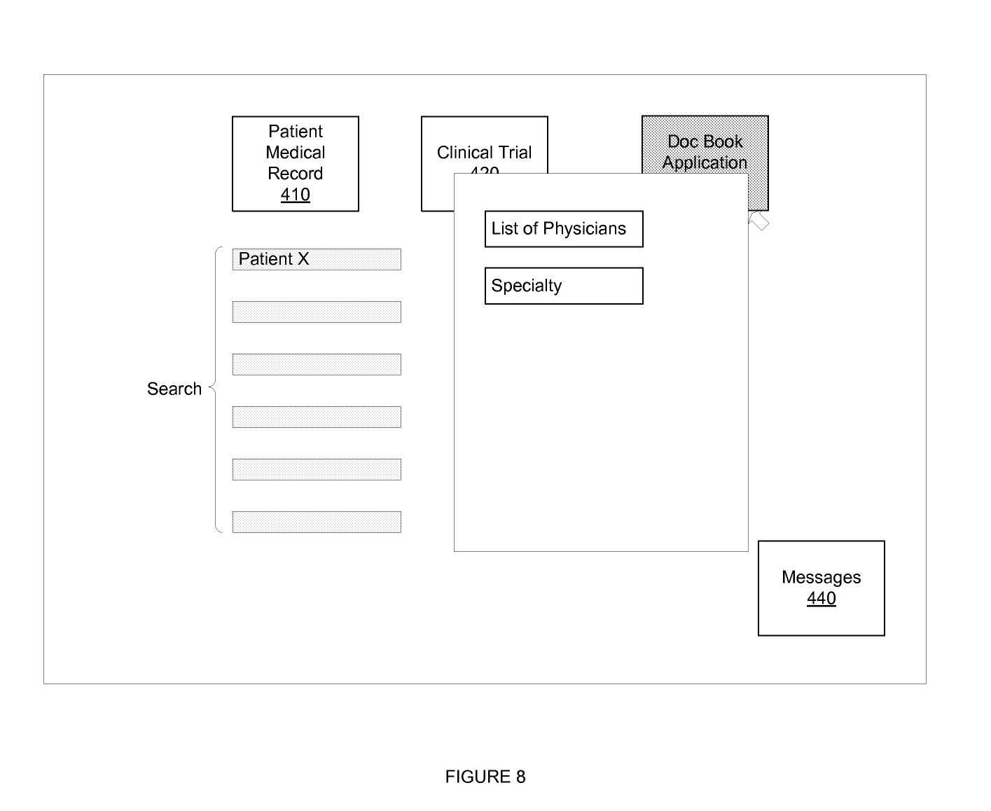

Referring now to FIGS. 4A-4B, exemplary graphical user interface associated with an electronic medical record in accordance with one embodiment of the present invention is shown. Referring specifically to FIG. 4A, a graphical user interface (GUI) facilitating a clinical research and interactions with patient electronic medical record stored in a server is shown. The GUI may include a patient medical record 410, a clinical trial 420, a doc book application 430, and messages 440 graphical elements. It is appreciated that the GUI may include additional or fewer fields. The GUI associated with the selection of the patient medical record 410 is described with respect to FIGS. 5A-5G below. The GUI associated with the selection of the clinical trial 420 is discussed in FIGS. 6A-6E in one embodiment, and further discussed with respect to FIG. 7A-7P in another embodiment. The GUI associated with the selection of the doc book application 430 is discussed with respect to FIG. 8.

The search fields enable one to search for any information. For example, the search field may be used to search for a patient using patient's name, address, social security number, etc. Moreover, the search fields may be used to search for a health condition, e.g., patients with Crohn's disease, patients with colon cancer, etc. It is appreciated that the search field may be used to search for any information stored as part of patient medical record and/or clinical trial. For example, the search field may be used to locate patients within a given geographical location.

According to one embodiment, the messages 440 graphical element may be selected in order to launch and initiate a messaging program, e.g., electronic mail, instant messaging, etc. In one embodiment, initiation of the message 440 graphical element enables one to send and receive messages. Moreover, in one exemplary embodiment, initiation of the message 440 graphical element enables information associated with a clinical trial, patient medical record, etc., to be shared in accordance with HIPAA.

Referring now to FIG. 4B, a user selection of patient medical record 410 is shown. As a result, a GUI 500 associated with patient medical record may be displayed, as shown by FIG. 5A. The GUI may include a plurality of graphical elements. It is appreciated that one or more of the graphical elements may be user selectable.

In this embodiment, the GUI 500 includes a name 510 graphical element, birth date 512 graphical element, social security 514 graphical element, address 516 graphical element, credit card 518 graphical element, telephone 520 graphical element, gender 522 graphical element, race 524 graphical element, patient condition 526 graphical element, patient history 527 graphical element, physical exam 528 graphical element, test results 529 graphical element, diagnosis 530 graphical element, treatment 532 graphical element, and a date 540 graphical element. It is appreciated that the graphical elements shown are exemplary and not intended to limit the scope of the present invention.

It is appreciated that the name 510, the birth date 512, the social security 514, the address 516, the credit card 518, the telephone 520, the gender 522, and the race 524 graphical elements may be user selectable. For example, selection of the name 510 enables one to type in the patient's name. Moreover, selection of the birth date 512, the social security 514, the address 516, the credit card 518, the telephone 520, the gender 522, and the race 524 graphical elements enable one to enter the date of birth, the social security number, the address, the credit card information, the telephone number, the gender and the race associated with a given patient.

The patient condition 526, the patient history 527, the physical exam 528, the test results 529, the diagnosis 530, and the treatment 532 graphical elements are associated with patient's health. As such, information associated with the patient condition 526, the patient history 527, the physical exam 528, the test results 529, the diagnosis 530, and the treatment 532 may be updated during each patient visit.

Referring now to FIG. 5B, a selection of the patient condition 526 graphical element in accordance with one embodiment of the present invention is shown. It is appreciated that the selection of the patient condition 526 may display the patient's condition from prior office visits (not shown). In this exemplary embodiment, a new graphical window may be displayed in order for the physician or the nurse to enter, e.g., type in, dictate, etc., the patient's current condition. Patient's condition generically refers to any complaints from the patient regarding the patient's health. In this example, the patient is complaining of chest pain. The patient has indicated being nauseous, and complaining of episodes of vomiting, and diaphoresis (sweating). Moreover, the patient indicates that the pain radiates to the left shoulder and down the left arm, becoming worst with mild physical activity. Accordingly, the complaint by the patient may be entered and stored, e.g., by the database 112.

It is appreciated that the entering of data may be manual, e.g., typing.

However, it is appreciated that the entering of data may be through other means, e.g., voice recognition, dictation, etc. As such, throughout the instant application, entering of data is not limited to typing but it may include handwriting recognition entry, voice recognition entry, dictation, etc.

Referring now to FIG. 5C, selection of the patient history 527 graphical element in accordance with one embodiment of the present invention is shown. The patient history may generically refer to the patient's family history, patient's medical history, patient's social history, etc. It is appreciated that the list provided is exemplary and not intended to limit the scope of the present invention.

It is appreciated that the selection of the patient history 527 may display the patient's history from prior office visits (not shown). In this exemplary embodiment, a new graphical window may be displayed in order for the physician or the nurse to type in the patient's medical history.

It is appreciated that the family history may refer to health condition of family members. For example, whether the parents have suffered from heart attack, or whether there has been diabetics within the family members can be indicated. Patient's medical history may be patient specific history, e.g., patient may have had chemotherapy in the past to treat colon cancer, etc. Patient's social history may refer to the social habits such as smoking, drinking, etc. It is appreciated that the patient's history may be entered and stored, e.g., by the database 112, for later retrieval.

Referring now to FIG. 5D, selection of physical exam 528 graphical element in accordance with one embodiment of the present invention is shown. It is appreciated that the selection of the physical exam 528 may display the physical examination from prior office visits (not shown). In this exemplary embodiment, a new graphical window may be displayed such that the results of the physical exam 528 may be entered. In this example, the vitals of the patient may be recorded. For example, the blood pressure, pulse, and the temperature may be recorded. Moreover, upon further examination, a wheezing sound, murmur and joint subluxation may also be recorded. The entered information may be stored, e.g., by the database 112.

Referring now to FIG. 5E, selection of the test results 529 graphical element in accordance with one embodiment of the present invention is shown. For example, the result of an X-ray, MRI, blood work, colonoscopy, endoscopy, biopsy, etc. may be entered and recorded. It is appreciated that the selection of the test results 529 may display prior test results associated with previous office visits (not shown).

Referring now to FIG. 5F, selection of the diagnosis 530 graphical element in accordance with one embodiment of the present invention is shown. It is appreciated that selection of diagnosis 530 graphical element may display diagnosis associated with prior office visits (not shown). In this example, selection of diagnosis 530 displays a new graphical window for recording the physician's finding as it relates to the diagnosis of patient's discomfort and suffering. It is appreciated that diagnosis generically refers to the condition that the patient is suffering from. In this example, the physician may have determined that the patient is suffering from coronary artery disease based on artery blockage seen on a coronary angiogram showing a left anterior descending artery (LAD) block of 55%. Moreover, the physician may determine that the patient is additionally or alternatively is suffering from rheumatoid arthritis, chronic obstructive pulmonary disease (COPD), Crohn's disease, and hepatotoxicity which started on Jan. 1, 2010 and resolved on Feb. 1, 2010. Accordingly, information regarding the diagnosis of the patient may be recorded and stored, e.g., by the database 112.

Referring now to FIG. 5G, selection of the treatment 532 graphical element in accordance with one embodiment of the present invention is shown. It is appreciated that the selection of the treatment 532 icon may display prior treatment associated with prior office visits. For example, the selection of the treatment 532 icon may display that the patient has been on atorvastatin (Lipitor™) 20 mg by mouth once daily from Jan. 1, 2010 to the present date. Moreover, the selection of the treatment 532 icon may also display that the patient has been on atenolol (Tenormin™) 50 mg by mouth once daily from Nov. 11, 2009 to the present date, and that the patient has been on simvastatin (Zocor™) 40 mg by mouth once daily between Nov. 11, 2009 and Jan. 1, 2010, which was discontinued due to liver toxicity and elevation of the liver enzymes.

Moreover, the selection of the treatment 532 may enable the physician to record new treatment associated with the current findings and office visit. In this example, the physician may indicate an adverse event (AE) of hepatoxicity (liver toxicity, seen with the abnormal elevation of the liver enzymes AST 154 and ALT 163 on Jan. 1, 2010) due to simvastatin, which is appropriately treated with the discontinuation of the medication. It is appreciated that the recorded information associated with the treatment may be stored, e.g., by the database 112.

It is appreciated that entering the findings and appropriate treatment may occur in a new graphical window instead of being added on to the window associated with prior treatment history. Moreover, it is appreciated that data entry, as described in FIGS. 5B-5F, may occur within the same window instead of a new window. As such, data entry within a new graphical window is exemplary and not intended to limit the scope of the present invention.

Is it appreciated that at the end of data entry the date 540 graphical icon may be selected in order to time stamp the entered data. However, it is appreciated that the information may be saved and time stamped automatically when the graphical window is closed or the information is saved by selecting the save graphical element (not shown). As such, the use of the date 540 graphical icon is exemplary and not intended to limit the scope of the present invention.

Referring now to FIG. 6A, a GUI associated with a clinical trial 420 in accordance with one embodiment of the present invention is shown. It is appreciated that the selection of the clinical trial 420 may display a plurality of research criteria 610-630, one or more comparison factors 640, etc.

Clinical research criteria may be any criteria of interest to be investigated, e.g., age group, geographical location, gender, race, sample size, insurance type, symptoms, diagnosis, laboratory values, treatments, drug classifications, drugs, duration, patient condition, test results, patient history, physical exam, etc. It is appreciated that each of the clinical research criteria will be described in more detail with respect to FIGS. 7A-7P below. For example, one may be interested in investigating patients with a particular symptoms, or patients with a particular diagnosis, or patients with a particular history, or patients with a particular laboratory value, or patients being on a particular drug for a particular duration, etc. It is appreciated that the research criteria may be typed in and/or selected from a drop down menu, or received using voice recognition, dictation, etc. In order to identify patients that satisfy the desired research criteria, the “GO” 631 graphical element may be selected, as shown by FIG. 6B.

Referring now to FIG. 6C, a search result based on the received research criteria in accordance with one embodiment of the present invention is shown. For example, electronic medical record of patients stored on a server, e.g., database 112, may be accessed to identify the patients that satisfy the research criteria. In this exemplary embodiment, patient 1 through patient N are patients that satisfy the requirements set forth by one or more of the received clinical research criteria.

In one embodiment, confidential information and private information associated with patient's identity is removed in accordance with HIPAA. For example, information associated with patient's identity may be removed in accordance with HIPAA when the search is being performed by someone other than the treating physician, e.g., drug manufacturer, a clinical researcher, a marketing person, etc. It is appreciated that each patient may be assigned a number as their corresponding identification instead of their confidential or private information associated with their identity. On the other hand, the search result may include information associated with patient's identity if the search is being performed by the treating physician because patient's privacy and confidentiality is protected by patient doctor privilege.

It is appreciated that a selection of any one of the patients from the search results may return additional information associated with the selected patient in accordance with HIPAA. For example, if the clinical research criteria is for identifying patients with Crohn's disease, selection of patient 2 from the search result may display additional information regarding patient 2. In this example, the additional information may indicate that patient 2 has also been diagnosed with Spondylitis and is currently taking etanercept (Enbrel™) and that the patient 2 lives in Los Angeles.

It is appreciated, that the messages 440 graphical element, as presented above may be used to facilitate communication between two or more entities. For example, during a clinical research, a clinical researcher may discover that a diagnosis associated with patient N may have been missed by the treating physician. Accordingly, the messages 440 graphical element may be used to communicate the information associated with patient N to the treating physician. It is appreciated that even though the clinical researcher cannot identify the identity of patient N, the number assigned to patient N may be used by the system to identify the identity of patient N to the treating physician. Thus, the identity of patient N remains unknown to the clinical researcher while the identity can be revealed to the treating physician.

Referring now to FIG. 6D, a plurality of fillable fields may be displayed to be filled out in a retrospective and/or prospective clinical study. For example, in a retrospective study, the fillable fields may be associated with and displayed for each patient identified by the search result. However, the fillable fields may be for prospective clinical study where no search has been performed but rather the questions are displayed to be answered in order to identify patient candidates for a particular clinical research study.

The fillable fields may include questions for patient 650, questions for physician 660, physical examination 670, and lab results 680. It is appreciated that according to one embodiment the fillable fields may be displayed in response to the search results in a retrospective clinical research study. For example, the fillable fields may be displayed to the physician treating the patients identified by the search result performed by a clinical researcher other than the treating physician. It is appreciated that the plurality of fillable fields may be displayed automatically when the treating physician logs in to his/her account. It is further appreciated that the information supplied by the physician may be tracked in a reward program associated with that physician.

In one exemplary embodiment, the fillable fields may be designated by the designer of the clinical research. For example, the designer of the clinical research may designate a question for the physician whether the patient diagnosed with Crohn's disease who is currently on an anti tumor necrosis factor antibody has had tuberculosis (TB) screening done.

Questions for patient 650 may be questions to be answered by each patient. Questions for the physician 660 may be questions to be answered by a physician treating the patient. The physical examination 670 may partially or completely be filled automatically from the electronic medical record associated with each patient. However, it is appreciated that the physical examination 670 may also be filled out manually. Moreover, the lab results 680 may partially or completely be filled automatically from the electronic medical record associated with each patient. However, it is appreciated that in one embodiment the lab results may be filled out manually. It is appreciated that additional information may provided by the physician in the physical examination 670 and in the lab results 680.

It is appreciated that the answers may be transmitted to an address 685 as specified by the physician. Alternatively, the answers may be transmitted to the address 685 that is generated automatically, e.g., email address of a clinical researcher, email address of a drug manufacturer, email address of the clinical research designer, etc.

It is appreciated that the filled information may be submitted by pressing the submit 690 graphical element. The submission of the information may, however, occur automatically, e.g., when a graphical window is closed. It is further appreciated that the information may be submitted each time the patient visits, it may be scheduled to occur periodically at a predetermined time intervals, etc.

Referring now to FIG. 6E, a user selection of one or more comparison factors 640 in accordance with one embodiment of the present invention is shown.

Comparison factors may be any factor of interest to be compared between the patients that satisfy the clinical research criteria. For example, comparison factors may include age group, geographical location, gender, race, sample size, insurance type, symptoms, diagnosis, treatments, drug classifications, drugs, duration, patient condition, laboratory values, patient history, physical exam, demographic, etc. It is appreciated that each of the comparison factors will be described in more detail with respect to FIGS. 7A-7P below.

The comparison factors 640 enable one to compare one or more characteristics of patients identified by the one or more clinical research criteria. For example, patients of different races in two or more geographical locations with common symptoms may be compared. It is appreciated that the comparison factors may be typed in and/or selected from a drop down menu, or received using voice recognition, dictation, etc.

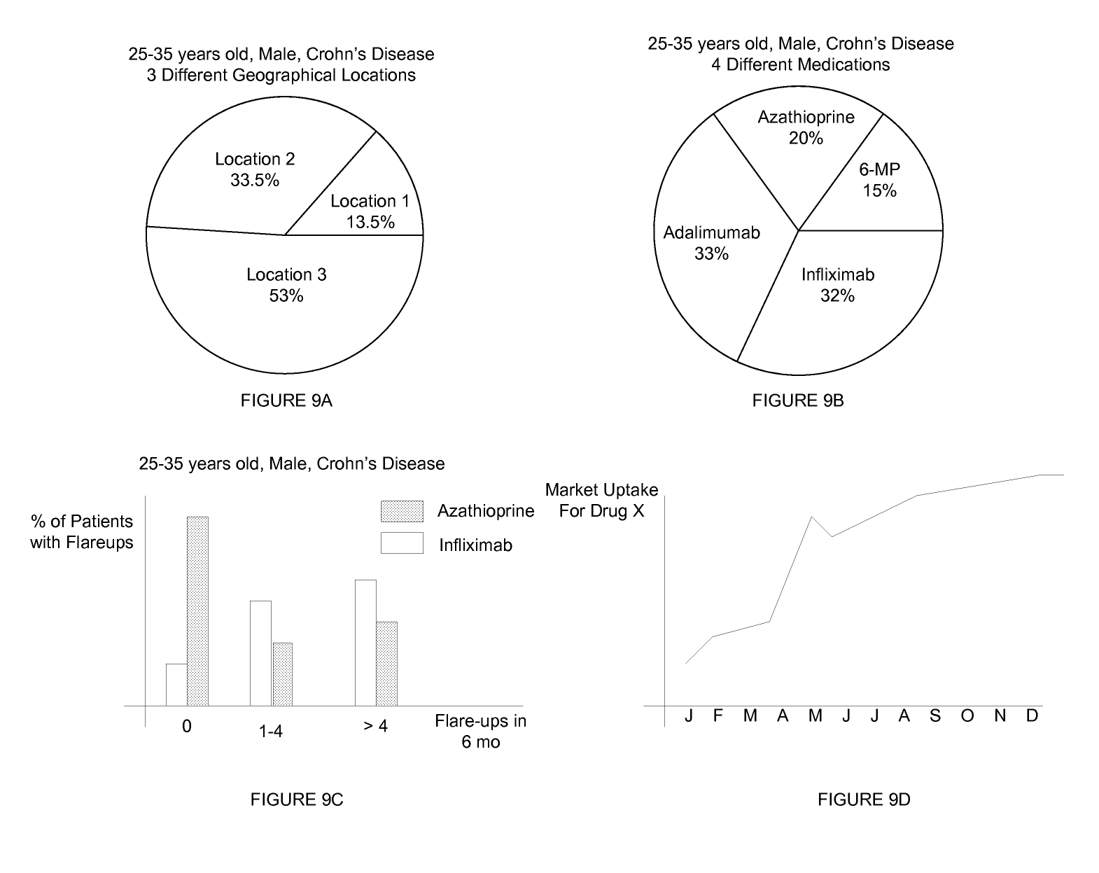

Accordingly, selection of one or more comparison factors cause information associated with the comparison factors that are further associated with patients satisfying the clinical research criteria to be processed. For example, information associated with the comparison factors of the identified group of patients based on the clinical research criteria that are stored in a server, e.g., database 112, may be accessed and processed. The exemplary result of the comparison may be displayed, as shown with respect to FIGS. 9A-9D.

It is appreciated that the information displayed is in compliance with the requirements of HIPAA. For example, confidential information associated with patient's identity may be displayed to the physician treating the patient whereas that information is purged and removed for entities other than the treating physician. In other words, removal of information in accordance with HIPAA opens up a databank of information associated with one or more patient to entities other than the treating physician. The databank of information associated with patients may be manipulated automatically to extract information regarding efficacy of a particular drug, drug-drug interactions, drug related adverse events (side effects), comparison with other drugs in the same class, population based response differentiation, market share associate with a given drug, etc., while complying with the requirements of HIPAA.

Referring now to FIG. 7A, an exemplary GUI 700 associated with performing an automated clinical research in accordance with one embodiment of the present invention is shown. The GUI 700 includes a plurality of selectable graphical elements, e.g., age group 702, geographical location 704, gender 706, race 708, sample size 710, insurance type 712, symptoms 714, diagnosis 716, treatments 718, drug classifications 720, drugs 722, duration 724, patient condition 726, tests results 728, patient history 730, and physical exam 732, that may be designated as either clinical research criteria or comparison factors. The GUI 700 further includes a submit to doctor (to enroll) 734, messages 737, and return 736 graphical elements. The functionality of each graphical element is described with respect to FIGS. 7B-7P below. It is appreciated that a selection of a selectable graphical element may additionally present a plurality of selectable items and/or provide a field for receiving information, e.g., typed in, audio input, dictation, etc. Moreover, it is appreciated that interactions with the GUI 700 provides access to the electronic medical record stored by the server, e.g., database 112, and processing of the information thereof in accordance with HIPAA.

Referring now to FIG. 7B, selection of the age group 702 and its designation as the clinical research criteria in accordance with one embodiment of the present invention is shown. The age group 702 may be used to identify the age of interest. For example, an age range, youngest age, oldest age, selection of age from a dropdown menu, etc., may be selected. It is appreciated that the age group 702 may be associated with the comparison factors in similar fashion.

It is appreciated that the data entry or data selection with respect to FIGS. 7A-7P may be by typing in the information, dictation, audio input, selection via the dropdown menu, etc. As such, the method of data selection and/or entry is exemplary and not intended to limit the scope of the present invention.

Referring now to FIG. 7C, selection of the geographical location 704 and its designation as the clinical research criteria in accordance with one embodiment of the present invention is shown. The selection of the geographical location 704 may be used to select a city, state, country, select a geographical location from a dropdown menu, etc.

Referring now to FIG. 7D, selection of the gender 706 graphical element and its designation as the comparison factor in accordance with one embodiment of the present invention is shown. The gender 706 graphical element may be used to select male, female, and/or any gender.

Referring now to FIG. 7E, selection of the race 708 graphical element and its designation as the comparison factor in accordance with one embodiment of the present invention is shown. The race 708 may be used to select one or more race of interest. For example, a race may be typed in and/or selected from a dropdown menu or received via dictation, etc. Race may include Caucasians, Blacks, Asian, Native American, Hispanics, etc.

Referring now to FIG. 7F, selection of the sample size 710 and its designation as the clinical research criteria in accordance with one embodiment of the present invention is shown. It is appreciated that the sample size refers to the size of the sample to be selected for a particular clinical research study. In one embodiment, if a sample size is bigger than the available data in one server, additional servers storing additional electronic medical record may be accessed in order to service the requested sample size. It is appreciated that the sample size may be selected from a dropdown menu or it may be entered, e.g., typing, audio input (voice recognition), dictation, etc.

Referring now to FIG. 7G, selection of the insurance type 712 and its designation as the clinical research criteria in accordance with one embodiment of the present invention is shown. It is appreciated that the insurance type 712 may be selected from a dropdown menu and/or it may be entered, e.g., typing, audio input (voice recognition), etc. Insurance type may include PPO, HMO, Medicare, etc. Insurance type may be a type of insurance and/or insurance name.

Referring now to FIG. 7H, selection of the symptoms 714 and its designation as the clinical research criteria in accordance with one embodiment of the present invention is shown. It is appreciated that the symptoms may be entered and/or selected from a dropdown menu. Symptoms generically refer to symptoms associated with a patient, disease, etc. For example, symptoms may include chills, headache, fever, nausea, vomiting, chest pain, etc.

Referring now to FIG. 71, selection of diagnosis 716 and its designation as the clinical research criteria in accordance with one embodiment of the present invention is shown. It is appreciated that diagnosis may be the identification of a disease by a treating physician. For example, a diagnosis may be a blocked artery, Crohn's disease, or colon cancer, etc. Diagnosis 716 may be entered and/or selected from a dropdown menu.

Referring now to FIG. 7J, selection of treatments 718 and its designation as the clinical research criteria in accordance with one embodiment of the present invention is shown. It is appreciated that treatment is generally the manner by which a diagnosis, disease, etc. is being dealt with. For example, a treatment for Crohn's disease may be to prescribe 6-mercaptopurine, or a treatment for coronery artery disease may be to prescribe clopidogrel (Plavix™), etc. Treatment may be identified by entering the treatment of interest and/or selecting it from a dropdown menu.

Referring now to FIG. 7K, selection of drug classification 720 and its designation as the clinical research criteria in accordance with one embodiment of the present invention is shown. Drug classification generically refers to the type of drug, e.g., anti-TNF blockers such as etanercept (Enbril™), infliximab (Remicade™), adalimumab (Humira™), etc. It is appreciated that the drug classification may be selected from a dropdown menu and/or by entering it, e.g., typing, audio input, etc.

Referring now to FIG. 7L, selection of drugs 722 and its designation as the clinical research criteria in accordance with one embodiment of the present invention is shown. Drugs refer to the actual prescription drug being used or the prescription drug of interest. The particular drugs of interest may be either selected from a dropdown menu and/or it may be typed in.

Referring now to FIG. 7M, selection of duration 724 and its designation as the clinical research criteria in accordance with one embodiment of the present invention is shown. Duration may include duration of an illness, duration of a treatment, duration that a specific drug has been used, duration that a specific class of drugs has been used, etc. It is appreciated that the duration may be selected from a dropdown menu and/or it may be typed in.

It is appreciated that patient condition 726, test results 728, patient history 730, and physical exam 732 are similar to that of patient medical record described with respect to FIGS. 5A-5F above.

Referring now to FIG. 7N, selection of submit to doctor 734 graphical element in accordance with one embodiment of the present invention is shown. For example, selection of the submit to doctor 734 icon may transmit the selected information, e.g., one or more clinical research criteria and/or one or more comparison factors, to a selected physician in order to access information associated with the query. It is appreciated that the selected information may be submitted to a physician in order for a group of patients, as identified by the clinical research criteria, to be enrolled in a clinical research study.

Referring now to FIG. 7O, selection of return 736 graphical element in accordance with one embodiment of the present invention is shown. For example, selection of the return 736 icon transmits the selected information, e.g., one or more clinical research criteria and/or one or more comparison factors, to one or more servers, e.g., database 112, storing electronic medical records. As such, the query may be serviced and information associated therein may be processed and the result may be returned to the querying party.

Referring now to FIG. 7P, selection of messages 737 icon in accordance with one embodiment of the present invention is shown. It is appreciated that the messages 737 icon may be used to launch an electronic mail application, an instant messaging application, etc., between two or more entities of the system, e.g., a clinical researcher, a physician, a drug manufacturer, etc. Moreover, it is appreciated that the messages 737 may operate substantially similar to that of messages 440 above.

Accordingly it is appreciated that the GUI 700 facilitates interactions between a researcher, a physician, etc., with a server storing electronic medical records associated with patients. Thus, information stored within the server may be accessed, manipulated, processed, and rendered in compliance with HIPAA.

It is appreciated that selection of one or more comparison factors cause information associated with the comparison factors that are further associated with patients satisfying the clinical research criteria to be processed. For example, information associated with the comparison factors of the identified group of patients based on the clinical research criteria that are stored in a server, e.g., database 112, may be accessed and processed. Exemplary results of the comparison are shown with respect to FIGS. 9A-9D. It is, however, appreciated that if no comparison factors is specified, the patients identified based on the clinical research criteria are displayed similar to that of FIGS. 6C and 6D in accordance with HIPAA. In one embodiment, if no comparison factors is specified, the patients identified based on the clinical research criteria are compared with respect to a subset of comparison factors (may be predetermined, default, user selectable, programmable, etc.) automatically.

It is appreciated that the information displayed is in compliance with the requirements of HIPAA. For example, confidential information associated with patient's identity may be displayed to the physician treating the patient whereas that information is purged and removed for entities other than the treating physician. In other words, removal of information in accordance with HIPAA opens up a databank of information associated with one or more patient to entities other than the treating physician. The databank of information associated with patients may be manipulated automatically to extract information regarding efficacy of a particular drug, drug-drug interactions, drug related adverse events (side effects), comparison with other drugs in the same class, population based response differentiation, market share associate with a given drug, etc., while complying with the requirements of HIPAA.

Referring now to FIG. 8, an exemplary graphical user interface associated with social networking of physicians in accordance with one embodiment of the present invention is shown. Doc book application 430 is a social networking application used by physicians. For example, a patient may be identified by entering the patient's name in the search field. Selecting the Doc book application 430 enables the physician to share various information stored in the electronic medical record of patient x with other physicians, soliciting advice, opinion, or simply creating an educational discussion. Furthermore other physicians who receive this information will be able to respond back and share their experience or thoughts with the posting physician or share it with all physicians. It is appreciated that the sharing of information by one physician with other physicians is in compliance with HIPAA.

In one embodiment, the doc book application 430 may be used to share information regarding one or more patient with other physicians subscribing to the doc book application 430. Information may be shared based on various criteria, e.g., specialty, list of physicians, physicians that are friends with the instant physician, etc. substantially in compliance with HIPAA.

Referring now to FIGS. 9A-9D, exemplary processed results associated with comparison factors in accordance with embodiments of the present invention are shown. For example, distribution over three geographical locations, as specified by comparison factors, for 25-35 year old males with Crohn's disease, as specified by the clinical research criteria, is shown, as shown by FIG. 9A. It is appreciated that the processed result may be rendered by displaying the result as a pie chart. However, it is appreciated that other types of graphical representation may be used, e.g., a bar graph, a plot, etc. Moreover, it is appreciated that the processed information displayed is in compliance with HIPAA. For example, in this exemplary embodiment, the processed information in compliance with HIPAA may be rendered to a clinical trial researcher who is other than the treating physician because no patient specific information associated with patient's identity is being revealed.

Referring now to FIG. 9B, distribution of four specific prescription drugs, as specified by comparison factors, for 25-35 year old males with Crohn's disease, as specified by the clinical research criteria, is shown. In this example the study looks at the market distribution of 4 different medications (6-MP, azathioprine, infliximab, and adalimumab) amounts the sample of patients. It is appreciated that the processed result may be rendered by displaying the result as a pie chart. However, it is appreciated that other types of graphical representation may be used, e.g., a bar graph, a plot, etc. Moreover, it is appreciated that the processed information displayed is in compliance with HIPAA. For example, in this exemplary embodiment, the processed information in compliance with HIPAA may be rendered to a clinical trial researcher who is other than the treating physician because no patient specific information associated with patient's identity is being revealed.

Referring now to FIG. 9C, distribution of the rate of flare-ups for two different prescription drugs (azathioprine vs. infliximab), as specified by comparison factors, for 25-35 years old males with Crohn's disease during the initial 6 month treatment period, as specified by the clinical research criteria, is shown. The output demonstrates the number of disease flare in this similar patient population being treated with two different medications in Crohn's disease. It is appreciated that the processed result may be rendered by displaying the result as a bar chart. However, it is appreciated that other types of graphical representation may be used, e.g., a pie chart, a plot, etc. Moreover, it is appreciated that the processed information displayed is in compliance with HIPAA. For example, in this exemplary embodiment, the processed information in compliance with HIPAA may be rendered to a clinical trial researcher who is other than the treating physician because no patient specific information associated with patient's identity is being revealed.

Referring now to FIG. 9D, market uptake of a newly approved prescription drug over a one year period in accordance with one embodiment of the present invention is shown. For example, the clinical research criteria may be the patients taking drug x and the comparison factors may include the variation of the number of patients on a monthly basis. It is appreciated that the processed result may be rendered by displaying the result as a curve. However, it is appreciated that other types of graphical representation may be used, e.g., a pie chart, a bar graph, etc. Moreover, it is appreciated that the processed information displayed is in compliance with HIPAA. For example, in this exemplary embodiment, the processed information in compliance with HIPAA may be rendered to a clinical trial researcher who is other than the treating physician because no patient specific information associated with patient's identity is being revealed.

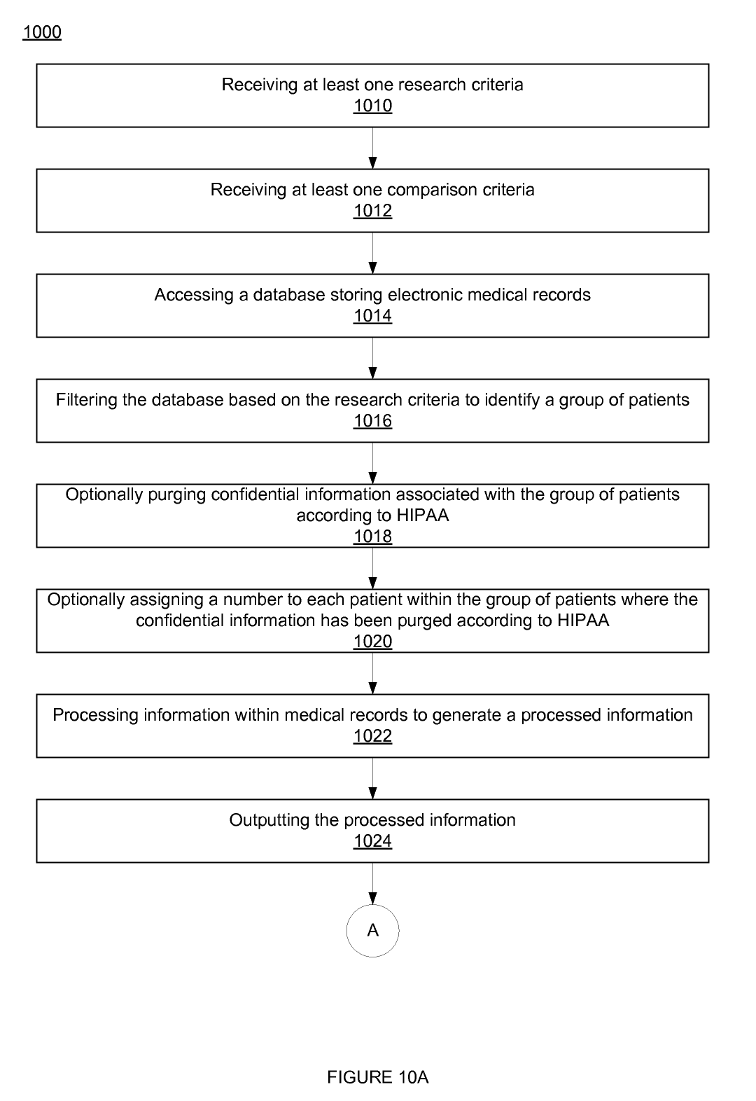

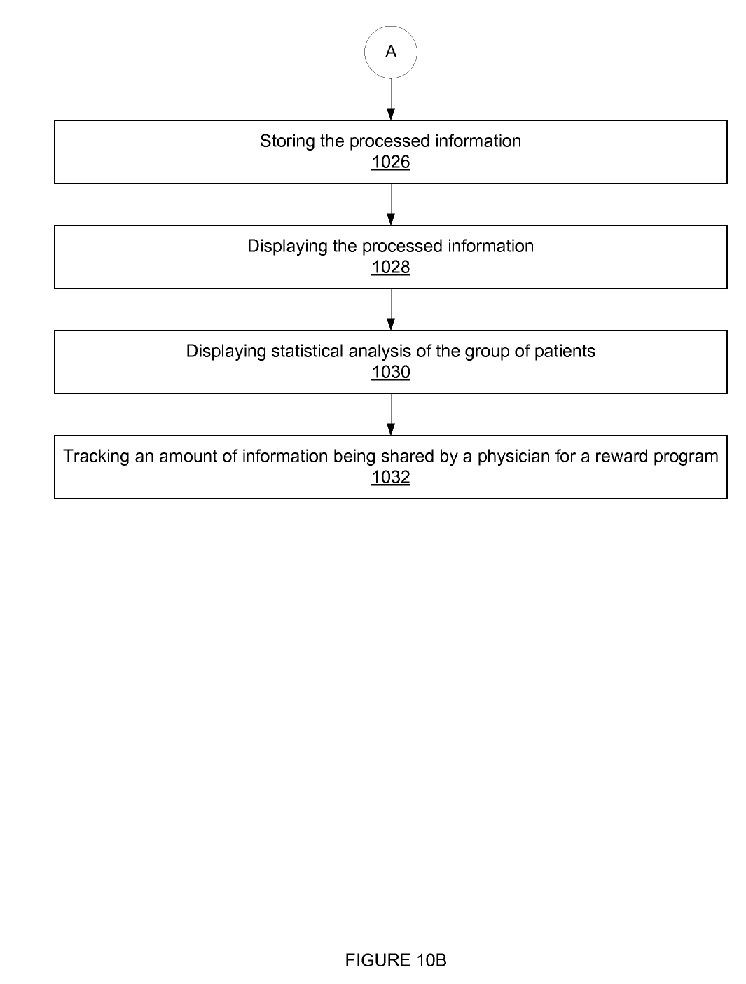

Referring now to FIGS. 10A and 10B, an exemplary flow diagram 1000 associated with an automated clinical research in accordance with one embodiment of the present invention is shown. At step 1010, at least one research criteria is received. Moreover, at step 1012, at least one comparison criteria is received. The research criteria and the comparison criteria may be received via user interactions with the GUI, as shown in FIGS. 6A-6E and FIGS. 7A-7P, as presented above. It is appreciated that the research criteria and/or the comparison criteria may be age group, geographical location, gender, race, sample size, insurance type, symptoms, diagnosis, treatments, drug classifications, drugs, duration, patient condition, tests results, patient history, and physical exam, etc., as described above.

At step 1014, a database storing electronic medical records of patients may be accessed. For example, the server comprising the database 112 may be accessed. It is appreciated that in one embodiment, accessing the database may be in response to receiving the research criteria.

It is appreciated that at step 1016, the information within the database may be filtered based on the research criteria. As such, a group of patients that satisfy the one or more research criteria may be identified. In one embodiment, at step 1018, confidential information associated with the identified group of patients is optionally purged in order to comply with the requirements of HIPAA. For example, confidential information associated with patient's identity may be purged before returning any information associated with that patient to an entity other than the treating physician. It is appreciated that at step 1020, a number may be optionally assigned to each patient within the identified group. According to one embodiment, the numbers may be assigned to each patient after the confidential information associated with identity of each patient is removed in compliance with HIPAA. Therefore, the identity of the patients remains confidential in accordance with HIPAA while each patient may be identified to the treating physician once the assigned number is matched with the list of identified patients within the group of patients.

At step 1022, information within medical records of the group of patients is processed. Thus, processed information is generated. The processed information may be based on the information associated with the one or more comparison criteria. At step 1024, the processed information is output, e.g., stored in a memory component, as shown at step 1026. It is appreciated that the processed information may be rendered by a display, as shown at step 1028. In one embodiment, at step 1030, a statistical analysis of the group of patients based on at least one comparison criteria may be displayed.

At step 1032, an amount of information being shared by a physician is tracked. For example, the number of patients that are enrolled in the clinical research study by the physician may be tracked. In one exemplary embodiment, the number of questions answered by the treating physician regarding each patient enrolled in the clinical research may be tracked. It is appreciated that any information supplied by the treating physician may be tracked. Each piece of information supplied by the treating physician may be given a reward weight. As such, a total reward point may be calculated to provide an incentive to the treating physicians to share information in compliance with HIPAA. The total reward point may be used to calculate compensation, gift, etc., associated with the clinical research for the treating physician.

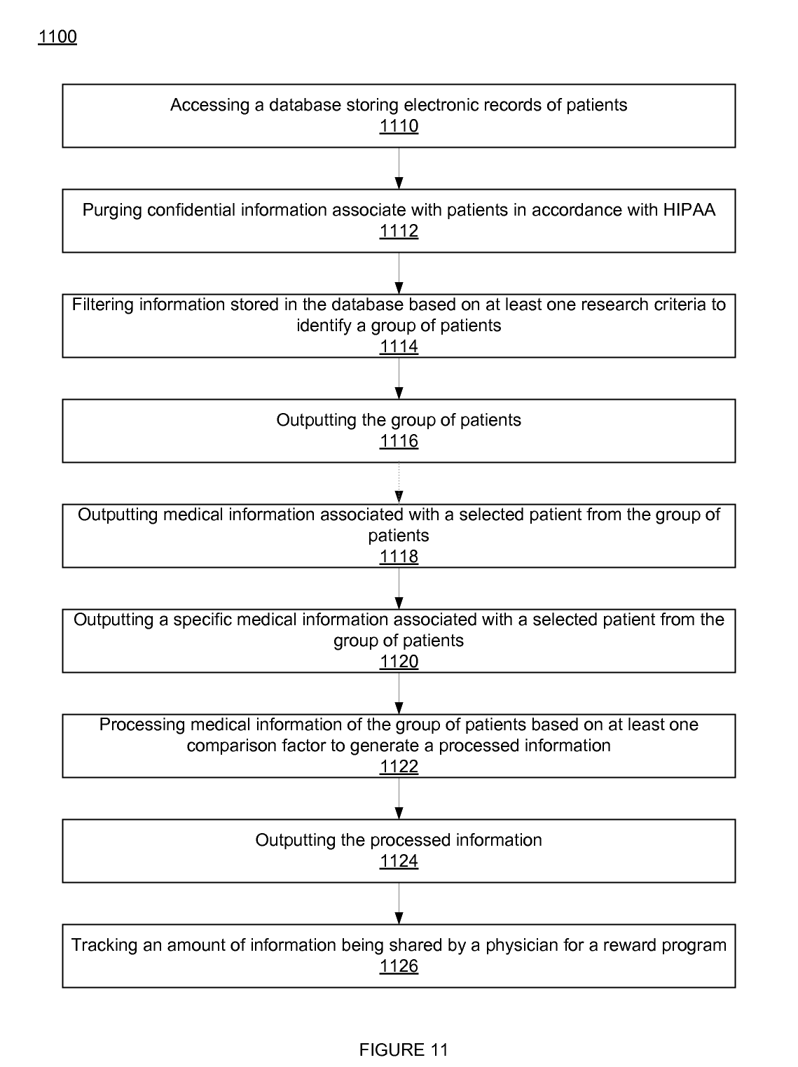

Referring now to FIG. 11, an exemplary flow diagram 1100 associated with an automated clinical research in accordance with one embodiment of the present invention is shown. According to one embodiment, at step 1110, a database storing medical records associated with patients is accessed. For example, the database 112 that stores electronic medical record of one or more patients may be accessed. At step 1112, confidential information associated with the patients may be purged in compliance with HIPAA.

At step 1114, information within the database may be filtered based on at least one research criteria. The research criteria may be received via user interactions with the GUI, as shown in FIGS. 6A-6E and FIGS. 7A-7P, as presented above. It is appreciated that the research criteria may be age group, geographical location, gender, race, sample size, insurance type, symptoms, diagnosis, treatments, drug classifications, drugs, duration, patient condition, tests results, patient history, and physical exam, etc., as described above. As such, a group of patients that satisfy the one or more research criteria is identified. According to one embodiment, at step 1116, the group of patents that satisfy the one or more research criteria may be output, e.g., rendered on a display. It is appreciated that a number of patients associated with the group of patients is adjustable based on a user selectable sample size.

It is appreciated that at step 1118, medical information associated with a selected patient may be provided, e.g., rendered on the display. For example, selection of a patient from the group of patients may display additional information from the electronic medical record of the selected patient in compliance with HIPAA. It is further appreciated that at step 1120, specific medical information associated with the selected patient may be displayed in response to a selection of the specific information. For example, after a patient is selected from the group of patients, selection of diagnosis selectable icon may display information related to the diagnosis associated with the selected patient. It is appreciated that the rendering of specific medical information is substantially in compliant with HIPAA.

At step 1122, medical information of the group of patients is processed based on at least one comparison factor. The comparison factor may be received via user interactions with the GUI, as shown in FIGS. 6A-6E and FIGS. 7A-7P, as presented above. It is appreciated that the comparison factor may be age group, geographical location, gender, race, sample size, insurance type, symptoms, diagnosis, treatments, drug classifications, drugs, duration, patient condition, tests results, patient history, and physical exam, etc., as described above. Thus, processed information is generated that is substantially compliant with HIPAA. According to one embodiment, the processing includes statistical analysis of the group of patients based on the one or more comparison factors. At step 1124, the processed information is output, e.g., to a memory component, to a display for rendering, etc.

At step 1126, an amount of information being shared by a physician is tracked. For example, the number of patients that are enrolled in the clinical research study by the physician may be tracked. In one exemplary embodiment, the number of questions answered by the treating physician regarding each patient enrolled in the clinical research may be tracked. In one example, the selected sample size associated with a treating physician may be used as a basis for tracking the reward points. It is appreciated that any information supplied by the treating physician may be tracked. Each piece of information supplied by the treating physician may be given a reward weight. As such, a total reward point may be calculated to provide an incentive to the treating physicians to share information in compliance with HIPAA. The total reward point may be used to calculate compensation, gift, etc., associated with the clinical research for the treating physician.

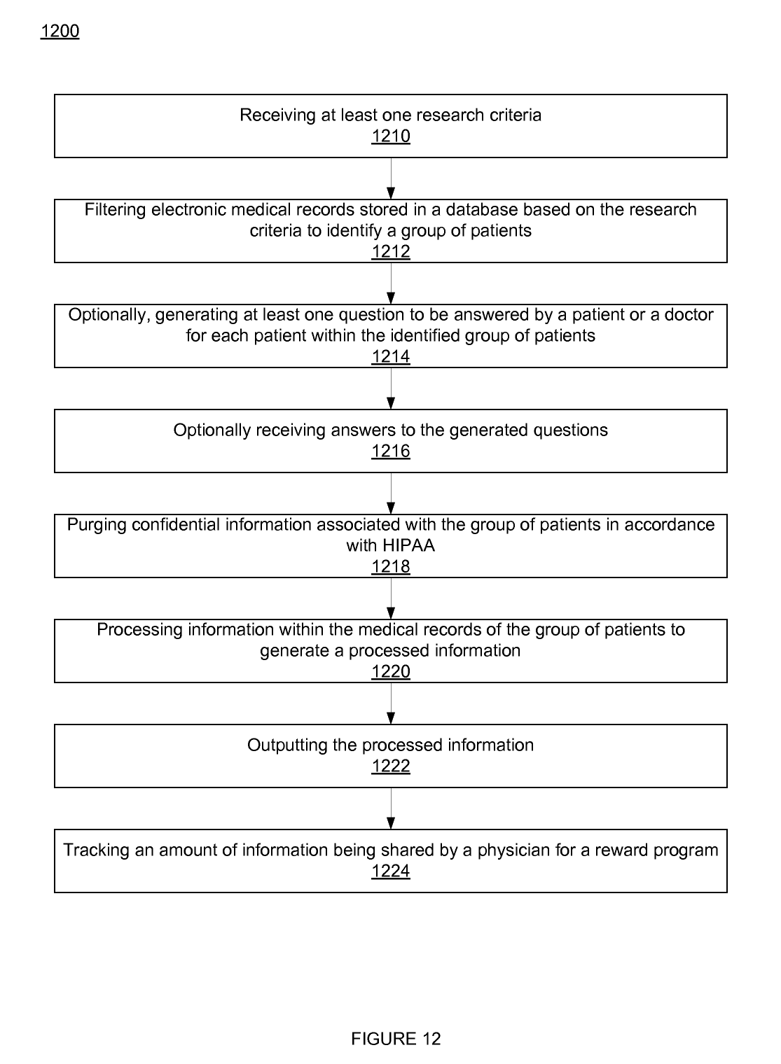

Referring now to FIG. 12, an exemplary flow diagram 1200 associated with an automated clinical research in accordance with one embodiment of the present invention is shown. At step 1210, one or more research criteria may be received. The research criteria may be received via user interactions with the GUI, as shown in FIGS. 6A-6E and FIGS. 7A-7P, as presented above. It is appreciated that the research criteria may be age group, geographical location, gender, race, sample size, insurance type, symptoms, diagnosis, treatments, drug classifications, drugs, duration, patient condition, tests results, patient history, and physical exam, etc., as described above.

At step 1212, information within a database, e.g., database 112, storing medical records associated with patients is filtered based on the one or more research criteria. Accordingly, a group of patients that satisfy the one or more research criteria is identified.

Optionally at step 1214, one or more questions are automatically generated as specified by the designer of the clinical research study. The questions may be for a treating physician to answer and/or for the patient within the identified group of patients to answer. The questions may include additional information regarding a physical examination of a patient, additional test results associated with a patient, etc. Accordingly, at step 1216, answers to the generated questions may be received.

It is appreciated that at step 1218, confidential information associated with the group of patients is purged in accordance with HIPAA. At step 1220, information within medical records of the group of patients is processed to generate processed information. It is appreciated that the processed information may be partially based on the received answers.

It is appreciated that the processed information may be associated with at least one or more comparison criteria that are different from the one or more research criteria. The comparison criteria may be received via user interactions with the GUI, as shown in FIGS. 6A-6E and FIGS. 7A-7P, as presented above. It is appreciated that the comparison criteria may be age group, geographical location, gender, race, sample size, insurance type, symptoms, diagnosis, treatments, drug classifications, drugs, duration, patient condition, tests results, patient history, and physical exam, etc., as described above. Thus, the processed information is generated that is substantially compliant with HIPAA. According to one embodiment, the processing includes statistical analysis of the group of patients based on the one or more comparison factors. At step 1222, the processed information is output, e.g., to a memory component, to a display for rendering, etc.

At step 1224, an amount of information being shared by a physician is tracked. For example, the number of patients that are enrolled in the clinical research study by the physician may be tracked. In one exemplary embodiment, the number of questions answered by the treating physician regarding each patient enrolled in the clinical research may be tracked. In one example, the selected sample size associated with a treating physician may be used as a basis for tracking the reward points. It is appreciated that any information supplied by the treating physician may be tracked. Each piece of information supplied by the treating physician may be given a reward weight. As such, a total reward point may be calculated to provide an incentive to the treating physicians to share information in compliance with HIPAA. The total reward point may be used to calculate compensation, gift, etc., associated with the clinical research for the treating physician.

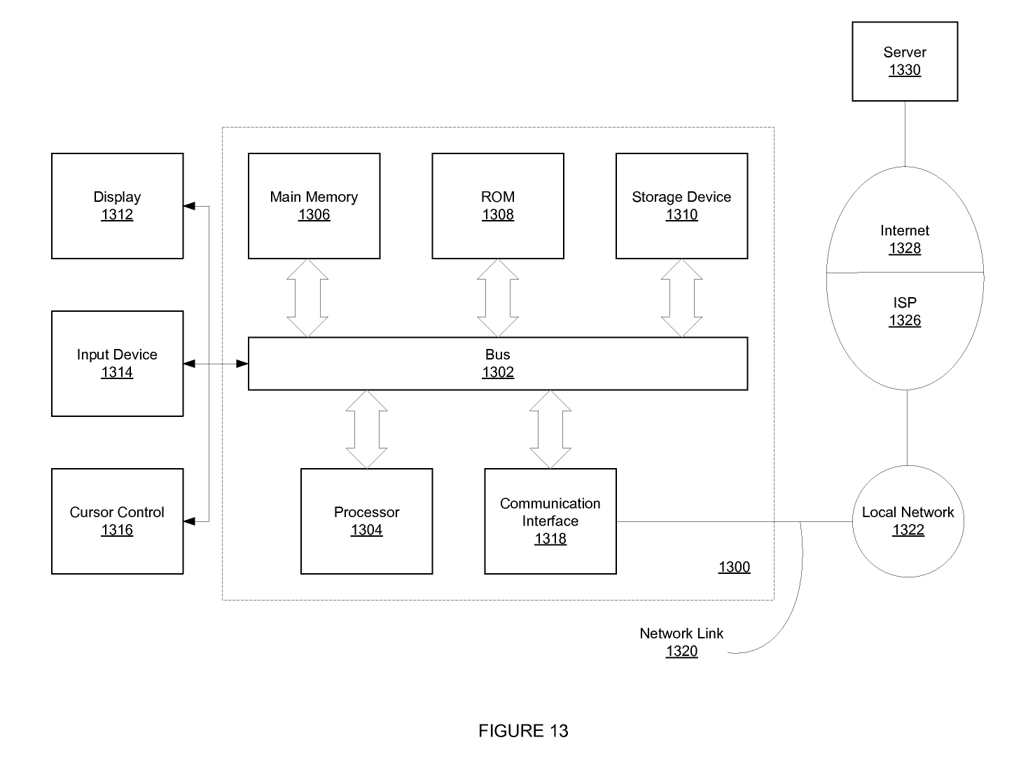

FIG. 13 is a block diagram that illustrates a computer system 1300 upon which an embodiment of the invention may be implemented. Computer system 1300 may implement the method for performing a clinical research as shown in FIGS. 1-12 and includes a bus 1302 or other communication mechanism for communicating information, and a processor 1304 coupled with bus 1302 for processing information. Computer system 1300 also includes a main memory 1306, such as a random access memory (RAM) or other dynamic storage device, coupled to bus 1302 for storing information and instructions to be executed by processor 1304. Main memory 1306 also may be used for storing temporary variables or other intermediate information during execution of instructions to be executed by processor 1304. Computer system 1300 further includes a read only memory (ROM) 1308 or other static storage device coupled to bus 1302 for storing static information and instructions for processor 1304. A non-volatile storage device 1310, such as a magnetic disk or optical disk, is provided and coupled to bus 1302 for storing information and instructions and may store the persistent internal queue.

Computer system 1300 may be coupled via bus 1302 to an optional display 1312, such as a cathode ray tube (CRT), for displaying information to a computer user. An optional input device 1314, including alphanumeric and other keys, may be coupled to bus 1302 for communicating information and command selections to processor 1304. Another type of user input device is cursor control 1316, such as a mouse, a trackball, or cursor direction keys for communicating direction information and command selections to processor 1304 and for controlling cursor movement on display 1312.

The term “computer-readable medium” as used herein refers to any medium that participates in providing instructions to processor 1304 for execution. Such a medium may take many forms, including but not limited to, non-volatile media, volatile media, and transmission media. Non-volatile media includes, for example, optical or magnetic disks, such as storage device 1310. Volatile media includes dynamic memory, such as main memory 1306. Transmission media includes coaxial cables, copper wire and fiber optics, including the wires that comprise bus 1302. Transmission media can also take the form of acoustic or light waves, such as those generated during radio wave and infrared data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, a carrier wave as described hereinafter, or any other medium from which a computer can read.

Computer system 1300 can send and receive messages through the network(s), network link 1320 and communication interface 1318. In the Internet example, a server 1330 might transmit a requested code for an application program through Internet 1328, ISP 1326, local network 1322 and communication interface 1318. The received code may be executed by processor 1304 as it is received, and/or stored in storage device 1310, or other non-volatile storage for later execution.

In the foregoing specification, embodiments of the invention have been described with reference to numerous specific details that may vary from implementation to implementation. Thus, the sole and exclusive indicator of what is, and is intended by the applicants to be, the invention is the set of claims that issue from this application, in the specific form in which such claims issue, including any subsequent correction. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method of facilitating medical research, said method comprising:
receiving at least one research criteria;
receiving at least one comparison criteria;
in response to said receiving said at least one research criteria, accessing a database storing medical records associated with patients;
filtering said database based on said at least one research criteria to identify a group of patients that satisfy said at least one research criteria;
processing information within medical records of said group of patients to generate processed information, wherein said information is associated with said at least one comparison criteria; and
outputting said processed information.

2. The method as described by claim 1 further comprising:
storing said processed information in a memory component.

3. The method as described by claim 1 further comprising:
displaying said processed information.

4. The method as described by claim 1, wherein said processing information comprises:
purging confidential information associated with said group of patients according to health insurance portability and accountability act (HIPAA).

5. The method as described by claim 4 further comprising:
subsequent to said purging, assigning a number to each patient within said group of patients.

6. The method as described by claim 1, wherein said at least one comparison criteria is selected from a group consisting of age, gender, race, geographical location, symptoms, diagnosis, treatment, insurance type, drug classification, and drug.

7. The method as described by claim 1 further comprising:
displaying statistical analysis of said group of patients based on said at least one comparison criteria.

8. The method as described by claim 1, wherein said at least one clinical research criteria is selected from a group consisting of age, gender, race, geographical location, symptoms, diagnosis, treatment, insurance type, drug classification, and drug.

9. A method of facilitating medical research, said method comprising:
accessing a database storing medical records associated with patients;
purging confidential information associated with said patients according to health insurance portability and accountability act (HIPAA);
filtering said database based on at least one research criteria to identify a group of patients that satisfy said at least one research criteria; and
outputting said group of patients operable to be rendered by a display.

10. The method as described by claim 9 further comprising:
outputting medical information associated with a selected patient from said group of patients operable to be rendered by said display, wherein said outputting is responsive to a selection of said selected patient, and wherein said medical information is substantially compliant with HIPAA.

11. The method as described by claim 10 further comprising:
outputting a specific medical information associated with said selected patient responsive to a selection of said specific information operable to be rendered by said display, wherein said specific medical information is substantially compliant with HIPAA.

12. The method as described by claim 9 further comprising:
processing medical information of said group of patients based on at least one comparison factor to generate processed information, wherein said processed information is substantially compliant with HIPAA; and
outputting said processed information operable to be rendered by said display.

13. The method as described by claim 12, wherein said at least one comparison factor is selected from a group consisting of age, gender, race, geographical location, symptoms, diagnosis, treatment, insurance type, drug classification, and drug.

14. The method as described by claim 12, wherein said processing comprises statistical analysis of said group of patients based on said at least one comparison factor.

15. The method as described by claim 9, wherein said at least one research criteria is selected from a group consisting of age, gender, race, geographical location, symptoms, diagnosis, treatment, insurance type, drug classification, and drug.

16. The method as described by claim 9, wherein a number of patients associated with said group of patients is adjustable based on a user selectable sample size.

17. A method of facilitating medical research, said method comprising:
receiving at least one research criteria;
in response to said receiving said at least one research criteria, filtering a database storing medical records associated with patients based on said at least one research criteria to identify a group of patients that satisfy said at least one research criteria;
processing information within medical records of said group of patients to generate processed information, wherein said information is associated with said at least one comparison criteria that is different from said at least one research criteria; and
outputting said processed information.

18. The method as described by claim 17 further comprising:
generating at least one question to be answered by a patient or a doctor of said patient within said group of patients; and
receiving answers to said at least one question, wherein said processing information is further based on said answers.

19. The method as described by claim 17, wherein said at least one clinical research criteria is selected from a group consisting of age, gender, race, geographical location, symptoms, diagnosis, treatment, insurance type, drug classification, and drug.

20. The method as described by claim 17, wherein said processing information comprises:
purging confidential information associated with said group of patients according to health insurance portability and accountability act (HIPAA).
